(19) United States
(12) Patent Application Publication
(10) Pub. No.: US 2016/0191338 A1
(43) Pub. Date: Jun. 30, 2016

(54) RETRIEVING CONTENT FROM AN APPLICATION

(71) Applicant: Quixey, Inc., Mountain View, CA (US)

(72) Inventors: Manikandan Sankaranarasimhan, Fremont, CA (US); Kalyan Desineni, Mountain View, CA (US); Vasanthakumar Sarpasayanam, Villianur (IN)

(73) Assignee: QUIXEY, INC., Mountain View, CA (US)

(21) Appl. No.: 14/585,115

(22) Filed: Dec. 29, 2014

(51) Int. Cl. H04L 12/24; G06F 3/0484

(52) U.S. Cl. CPC H04L 41/22; G06F 3/04842

(57) ABSTRACT

Some aspects of the disclosure provide a method comprising configuring an application into a first application state, the configuring performed using a first state access instruction associated with the first application state and resulting in a first output interface provided by the application, selecting a first UI element from the first output interface, the first UI element indicating first content, determining that the first UI element is of a first UI element type, selecting first UI content instructions corresponding the first UI element type, the first UI content instructions including a first set of actions to retrieve content indicated by UI elements of the first UI element type, and executing the first set of actions to retrieve the first content indicated by the first UI element.

### TECHNICAL FIELD

The present disclosure generally relates to retrieving content from an application and, more particularly, to techniques for copying content from applications when the applications are configured to different application states.

### BACKGROUND

As mobile devices have become more capable and common, there has been increased use of and reliance on mobile applications (i.e., applications on the mobile devices). The number of applications, types of functionality, and amount of content provided by these applications has exploded. Further, new applications as well as updated versions of existing applications with new content are added every day.

Most application developers publish a list of instructions to control or configure the application in different ways. For example, many ANDROID applications include or are associated with an application manifest. The manifest includes information that the operating system may require before the application is executed. The manifest may also identify intents that may configure the application to reach desired content from the application. An intent in ANDROID is a messaging object that can be used to request an action from another application (or a component of an application).

Unfortunately, as applications have gotten more complex and the information provided by applications has grown, there may be any number of intents and different configurations that are not published by the application developer. The task of identifying intents and different application configurations is often too onerous and burdensome on the application developer.

### SUMMARY

An example method comprises configuring an application into a first application state, the configuring performed using a first state access instruction associated with the first application state and resulting in a first output interface provided by the application, selecting a first UI element from the first output interface, the first UI element indicating first content, determining that the first UI element is of a first UI element type, selecting first UI content instructions corresponding the first UI element type, the first UI content instructions including a first set of actions to retrieve content indicated by UI elements of the first UI element type, and executing the first set of actions to retrieve the first content indicated by the first UI element.

Some aspects of the disclosure provide a method further comprising selecting a second UI element from the first output interface of the first application state, the second UI element indicating second content, determining that the second UI element is of a second UI element type, selecting second UI content instructions corresponding to the second UI element type, the second content instructions including a second set of actions to retrieve content indicated by the UI element of the second UI element type, and executing the second set of actions to retrieve the second content indicated by the second UI element.

In some embodiments, the method further comprises accessing a first UI element set corresponding to the first application state, the first UI element set including data describing a first set of UI elements included in the first output interface, the first UI element selected from the first set of UI elements. The method may comprise selecting, from a state access instruction report, the first state access instruction, the state access instruction report listing a set of state access instructions corresponding to a set of application states of the first application.

The method may comprise determining that each UI element from a set of UI elements of the first application has been selected, selecting, from the state access instruction report, a second state access instruction corresponding to a second application state of the first application. In various embodiments, the method comprises wherein executing the first set of actions comprises executing a developer provided standard instruction for the first UI element type, the developer provided standard instruction configured to return content indicated by UI elements of the first UI element type.

Some aspects of the disclosure provide a method wherein executing the first set of actions comprises retrieving the first content indicated by the first UI element, the first content presented in an initial view of the first UI element, actuating a first interactive element associated with the first UI element, resulting in a secondary view including a second content. Executing the first set of actions may further comprise retrieving the second content.

Executing the first set of actions may further comprise determining whether at least a portion of the second content has already been retrieved, wherein, when at least a portion of the second content has already been retrieved, the second content is not retrieved from the first UI element. In some embodiments, executing the first set of actions further comprises determining whether a termination condition has been met, wherein when a termination condition has been met, the termination condition indicating that no more content associated with the UI element should be retrieved.

Determining whether a termination condition has been met may comprise determining whether an amount of content retrieved associated with the first UI element meets or exceeds a predetermined threshold amount of content to be retrieved. Some aspects of the disclosure provide a method wherein determining whether a termination condition has been met comprises determining whether a length of elapsed time associated with retrieving content indicated by the first UI element meets or exceeds a threshold length of time to be spent retrieving content. In some embodiments, determining whether a termination condition has been met comprises determining whether a number of times that interactive elements associated with the first UI element have been actuated meets or exceeds a threshold number of interactive element actuations. Determining whether a termination condition has been met may comprise determining whether the first interactive element of the first element has been exhausted.

An example system may comprises an application state configuration module, an element selection module, and a scraper module. The application state configuration module may be configured to configure an application into a first application state, the configuring performed using a first state access instruction associated with the first application state and resulting in a first output interface provided by the application. The element selection module may be configured to select a first UI element from the first output interface, the first UI element indicating first content, and determine that the first UI element is of a first UI element type. The scraper module may be configured to select first UI content instructions corresponding the first UI element type, the first UI content instructions including a first set of actions to retrieve content indicated by UI elements of the first UI element type, and execute the first set of actions to retrieve the first content indicated by the first UI element.

An example non-transitory computer readable medium may comprise executable instructions. The instructions may be executable by a processor to perform a method. The method may comprise configuring an application into a first application state, the configuring performed using a first state access instruction associated with the first application state and resulting in a first output interface provided by the application, selecting a first UI element from the first output interface, the first UI element indicating first content, determining that the first UI element is of a first UI element type, selecting first UI content instructions corresponding the first UI element type, the first UI content instructions including a first set of actions to retrieve content indicated by UI elements of the first UI element type, and executing the first set of actions to retrieve the first content indicated by the first UI element.

### BRIEF DESCRIPTION OF THE DRAWINGS

FIG. 1 is an illustration of an environment including an application exploration system, a knowledge system, and application severs each in communication over a network in some embodiments.

FIG. 2 is an illustration of an example application state discovery engine in some embodiments.

FIG. 3 is a diagram of the generation of the state access instruction report and semantic meaning in some embodiments.

FIG. 4 is a portion of a state access instruction report in some embodiments.

FIG. 5 is a flowchart of an example method for discovering application states of an application.

FIG. 6 is a flowchart of an example method for identifying semantic meaning associated with an activity object and associated parameter variables (if any) in some embodiments.

FIG. 7 is a flowchart of an example method for linking parameter values with parameter variables.

FIG. 8 is a flowchart of an example method for discovering states of an application in a dynamic environment.

FIG. 9 shows an exemplary embodiment of the scraper engine in some embodiments.

FIG. 10 shows a flow diagram of a scraper engine scraping content from output interfaces generated by an application at different application states in some embodiments.

FIG. 11 shows a flow diagram of scraping content represented or indicated by a UI element in some embodiments

FIG. 12 is a flowchart of scraping content from an application state in some embodiments.

FIG. 13 is a flowchart of scraping content represented or indicated by a UI element in some embodiments.

FIG. 14 is a flowchart of scraping content represented or indicated by a UI element configured to provide multiple views in some embodiments.

FIG. 15 is illustrates an environment including a search system, user devices, and data sources in communication over a network in some embodiments.

FIG. 16 shows example interaction between the user device and search system in some embodiments.

FIGS. 17A and 17B show example application state records in some embodiments.

FIG. 18 provides an example arrangement of operations for a method of operating a user device.

FIG. 19 depicts a search module in some embodiments.

FIG. 20 is a block diagram of an exemplary digital device.

Like reference symbols in the various drawings indicate like elements.

### DETAILED DESCRIPTION

Software applications provide a considerable amount of content. Many applications require a user to navigate (e.g., press desired buttons or tabs) various screens provided by the application to achieve a desired application state where desired content is displayed. For example, a user may execute a review application on a mobile device and enter a type of food (e.g., American) and a zip code. A review application may be an application that enables users to receive reviews for businesses and services, such as restaurants, cleaning services, and the like. Upon entering a type of food and a zip code in a review application, the user may click a button or other icon to transition the review application from its initial screen (e.g., displayed by the review application when the application is in its initial application state) to a screen that displays a list of restaurants at the desired zip code (e.g., displayed by the review application when the application has been configured to a different application state using the entered restaurant type and zip code). Display of content by an application often depends on how the application is controlled, information from the user, and/or information from other applications and/or remote devices.

Some applications publish specific instructions to configure an application to an application state (e.g., a configuration of the application) to encourage users and/or other applications to configure the application to provide desired information. For example, many application developers create a publicly available manifest which includes, for example, ANDROID intent messages for the application. Each intent message may provide information to enable configuration of the application to one or more different application states. The information from the manifest may be used by users, applications, and/or services to improve accessibility and/or use of the application as well as application content. Not all application states for an application, however, are published by the application developer. For example, an application developer may create an application capable of achieving any number of states. The specific identification and publication of numerous states for an application by the application developer may be onerous and unwieldy.

Techniques are described for discovery of application states in an application. In various embodiments, the code of the application may be pre-processed and inspected to identify components of the code (e.g., objects) and usage that are linked to configuring the application to a different application state (e.g., a configuration of an application further described herein). In some embodiments, the application may be executed and the application configured (e.g., through the application graphical user interface or GUI). Commands to components and usage may be hooked or intercepted to identify code components and usage.

Once a component of the code and/or usage is identified, functional instructions may be created or generated to configure or assist in configuration of the application to the identified application state. In some examples, the functional instructions (e.g., state access instructions) may be used to direct users to desired content, to improve interoperability with other applications and services, display content, and/or provide improved access to content.

A software application may refer to computer software that causes a computing device to perform a task. In some examples, a software application may be referred to as an “application,” an “app,” or a “program.” Example applications include, but are not limited to, word processing applications, spreadsheet applications, messaging applications, media streaming applications, social networking applications, and games.

Applications can be executed on a variety of different computing devices. For example, applications can be executed on mobile computing devices such as smart phones, tablets, and wearable computing devices (e.g., headsets and/or watches). Applications can also be executed on other types of computing devices having other form factors such as laptop computers, desktop computers, or other consumer electronic devices. In some examples, applications may be installed on a computing device prior to a user purchasing the computing device. In other examples, the user may download and install applications on the computing device.

The functionality of an application may be accessed on the computing device on which the application is installed. Additionally, or alternatively, the functionality of an application may be accessed via a remote computing device. In some examples, all of an application's functionality is included on the computing device on which the application is installed. These applications may function without communication with other computing devices (e.g., via the Internet). In other examples, an application installed on a computing device may access information from other remote computing devices during operation. For example, a weather application installed on a computing device may access the latest weather information via the Internet and display the accessed weather information to the user through the installed weather application. In still other examples, an application (e.g., a web based application) may be partially executed by the user's computing device and partially executed by a remote computing device. For example, a web application may be an application that is executed, at least in part, by a web server and accessed by a web browser of the user's computing device. Example web applications may include, but are not limited to, web-based email, online auctions, and online retail sites.

An application state is a configuration of an application. For example, an application may store data in memory locations. The content of these memory locations, at a given point in the application's execution, is the application's state at that time. In various embodiments, an application may be configured to reach a particular state by a user that executes the application and navigates various interfaces to reach the desired application configuration (i.e., the desired application state). In another example, the application may receive instructions that call one or more functions and/or parameters (e.g., the instruction may include an ANDROID intent) that, when executed by the application, configures the application to an application state. An application may be configured to invoke or achieve an application state in any number of ways.

In various embodiments, an application may be configured to produce an output interface when the application is at a particular application state. The output interface is any output that the application may produce at that application state. For example, the output interface may include an html page or card that is displayable to a user of the digital device. The output interface may include functionality and/or content (e.g., maps and navigation, restaurant reviews, podcast information, or the like). Content is any information that provides value to a user. Examples of content may include descriptions, reviews, tutorials, email messages, GPS coordinates, or the like. The application may provide different output interfaces at different application states (e.g., the application may provide different content at different application states).

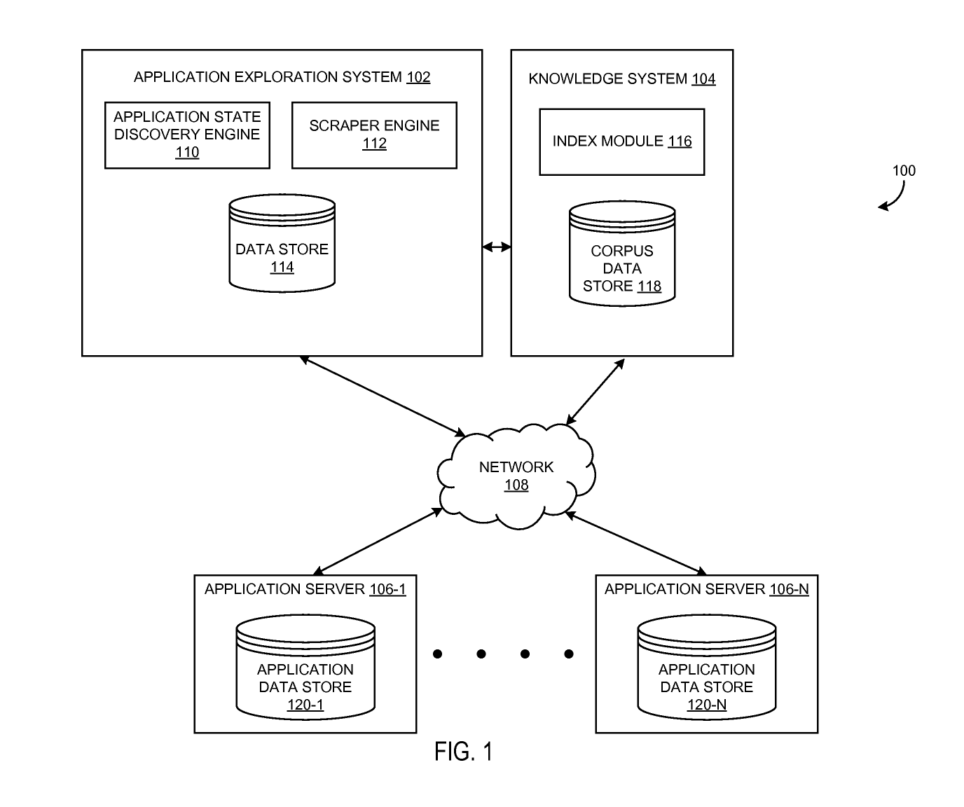

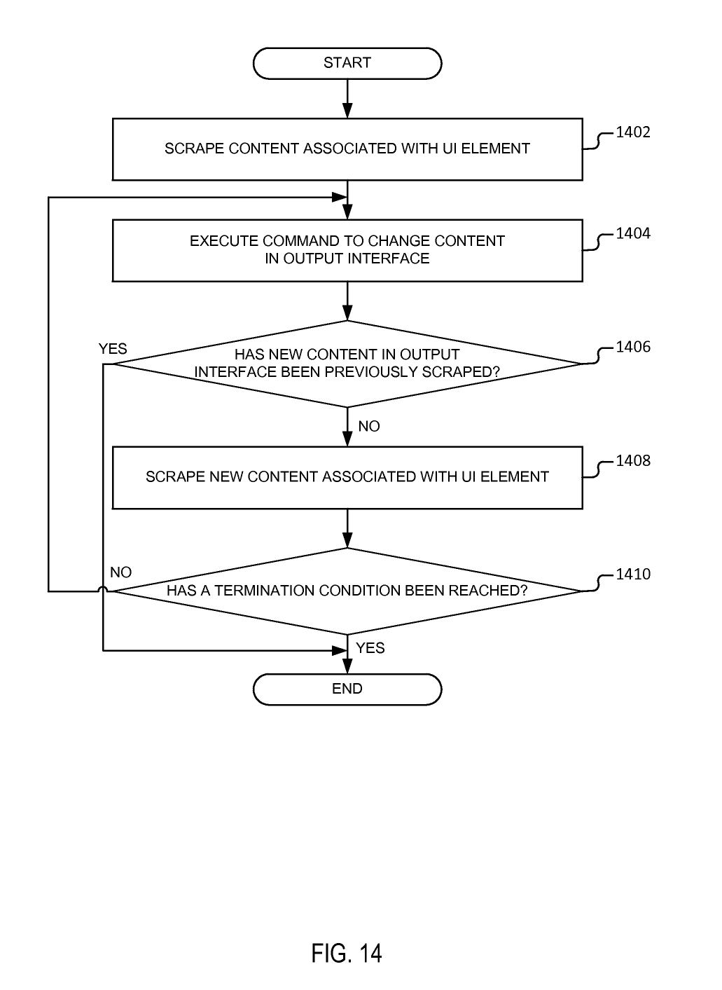

FIG. 1 is an illustration of an environment 100 including an application exploration system 102, a knowledge system 104, and application servers 106-1 . . . 106-N each in communication over a network 108 in some embodiments. The network 108 may include various types of networks, such as a local area network (LAN), a wide area network (WAN), and/or the Internet. The application exploration system 102, knowledge system 104, and application servers 106-1 . . . 106-N may be computing devices. A computing device (e.g., a digital device) is any device with a memory and a processor. An example of a digital device is depicted in FIG. 14.

The application exploration system 102 includes an application state discovery engine 110, a scraper engine 112, and a data store 114. In various embodiments, the application state discovery engine 110 is configured to discover any number of application states (e.g., possible configurations) of an application. Any number of the discovered application states may be associated with an output interface of the application. The output interface may include content that may be of value to a user, another application, service, or the like.

In some embodiments, once the application state discovery engine 110 discovers a desired application state (e.g., a configuration of an application), the application state discovery engine 110 may generate instructions (e.g., state access instructions) that, when executed, configures or assists in configuring the application to the desired application state. In one example, when the application is configured to achieve a particular application state using state access instructions, the application may display and/or generate an output interface to enable display of content.

The state access instruction may enable configuration of an application to access content from of functionality of the configured application. In some embodiments, a state access instruction may include a string that includes a reference to an application installed on a user's device (e.g., mobile phone or the like described herein). The string may indicate one or more operations for the user device to perform. In various embodiments, the application may be launched and the application may perform one or more operations indicated in the state access instruction.

The state access instruction may include an application resource identifier and/or one or more operations for a user device to perform. For example, an application resource identifier may be a string having an application specific scheme. The application resource identifier may include a reference to a native application and indicate one or more operations for the application to perform. For example, the application resource identifier may include a reference to the application, a domain name, and a path to be used by the native application to retrieve and display information to the user.

In some examples, the state access instruction may include operations for the application to perform in addition to the operation(s) indicated in the application resource identifier. In some examples, the operations may be included in a script. Examples of operations may include, but are not limited to, launching the application, waiting for the application to start, creating and sending a search request to a server, setting a current geo-location in the application, making a restaurant reservation, sending a text message, and adding an appointment to a calendar.

A state access instruction may be, for example, an application state access mechanism described herein.

State access instructions may include an application resource identifier and any associated parameter values (if any). In some embodiments, the state access instructions may include template function instructions. The application resource identifier may include, for example, instructions that identify or refer to a component of an application to perform an activity or service. Parameter values are any values that may be passed to the component of the application. In one example, an application resource identifier may identify or call a component within the review application that ultimately displays restaurants. The state access instructions may include a parameter value including a zip code for New York City. In this example, the state access instruction calls a component within the review application to perform a function utilizing the provided parameter function in order to configure the review application to display a list of restaurants in New York City.

In some embodiments, state access instructions include a template function instruction that includes an application resource identifier as well as one or more parameter variables. A parameter variable is any indicator or reference to a parameter value.

The data store 114 may be any memory configured to store, for example, state access instructions, template function instructions of state access instructions, application resource identifiers, parameter variables, and/or parameter values. The corpus data store 118 may also store content and/or UI elements.

The application exploration system 102 may further include a scraper engine 112. In various embodiments, the scraper engine 112 may be configured to gather content from any number of applications. In some embodiments, an application may be configured to a specific application state using a state access instruction discovered by the application state discovery engine. The scraper engine 112 may subsequently copy content from an output interface generated by the application at that application state. The scraper engine 112 may copy any content including, but not limited to, text, images, audio, video, or the like.

In some embodiments, the scraper engine 112 may also scrape user interface (UI) elements from the output interface. UI elements are those elements used in an interface (e.g., a graphical user interface or GUI) that represent information indicated in that interface. UI elements may indicate content (e.g., text, image, audio, video, animation, or any media either locally stored or retrievable over a network). In one example when the output interface is coded in xml, a UI element may indicate content by defining TextView as android:text=“Restaurant review for Alexander's Steakhouse is five stars.” In various embodiments, the UI element may include a link to another application, data store, and/or a remote digital device to retrieve content to be shared with the user

UI elements may indicate and/or describe functionality (e.g., buttons, scroll bars, tabs, or the like). For example, UI elements for a particular output interface may indicate a window for content and a scroll bar associated with that window which may change the content of the window when actuated (e.g., when the window scrolls as a result of activation of the scroll bar).

In various embodiments, the scraper engine 112 may scrape an output interface depending on the UI element(s). For example, the scraper engine 112 may identify a UI element and perform functions based on the type of UI element. In some embodiments, each UI element may be associated with any number of scraper instructions. The scraper engine 112 may scrape content associated with a UI element based on the scraper instructions. Since not all UI elements may be associated with content, there may be scraper instructions that instruct the scraper engine 112 to take no action or to scan for a different UI element.

The knowledge system 104 may include index module 116 and corpus data store 118. The knowledge system 104 may be configured to store state access instructions from the application state discovery engine 110, content and/or UI elements copied from the scraper engine 112 or the like. For example, the index module 116 may index and/or categorize information identified by the application exploration system 102. In some embodiments, the index module 116 indexes state access instructions, template function instructions of state access instructions, application resource identifiers, parameter variables, and/or parameter values. The index module 116 may index and/or categorize information identified by the scraper engine 112 including content and/or UI elements. In various embodiments, the index module 116 may index, categorize, or otherwise associate information from the scraper engine 112 with information from the application state discovery engine 110. In some embodiments, the index module 116 may index, categorize, or otherwise associate state access instructions, template function instructions of state access instructions, application resource identifiers, parameter variables, and/or parameter values with each other.

The corpus data store 118 may be any memory configured to store, for example, state access instructions, template function instructions of state access instructions, application resource identifiers, parameter variables, and/or parameter values. The corpus data store 118 may also store content and/or UI elements.

The application servers 106-1 . . . 106-n are any digital devices that may include application data store 120-1 . . . 120-n, respectively. In various embodiments, the application servers 106-1 . . . 106-n may provide information to an application. For example, the review application may retrieve information from the application data store 120-1 to display to a user. In another example, if the review application is configured (e.g., using a state access instruction) to a particular application state, the review application may generate an output interface and display information from the application server 106-1 in the output interface.

Modules, engines, and data stores included in the application exploration system 102 knowledge system 104, and elsewhere in the description, represent features. The modules and data stores described herein may be embodied by electronic hardware (e.g., an ASIC), software, firmware, or any combination thereof. Depiction of different features as separate modules and data stores does not necessarily imply whether the modules and data stores are embodied by common or separate electronic hardware or software components. In some implementations, the features associated with the one or more modules and data stores depicted herein may be realized by common electronic hardware and software components. In some implementations, the features associated with the one or more modules and data stores depicted herein may be realized by separate electronic hardware and software components.

The modules and data stores may be embodied by electronic hardware and software components including, but not limited to, one or more processing units, one or more memory components, one or more input/output (I/O) components, and interconnect components. Interconnect components may be configured to provide communication between the one or more processing units, the one or more memory components, and the one or more I/O components. For example, the interconnect components may include one or more buses that are configured to transfer data between electronic components. The interconnect components may also include control circuits (e.g., a memory controller and/or an I/O controller) that are configured to control communication between electronic components.

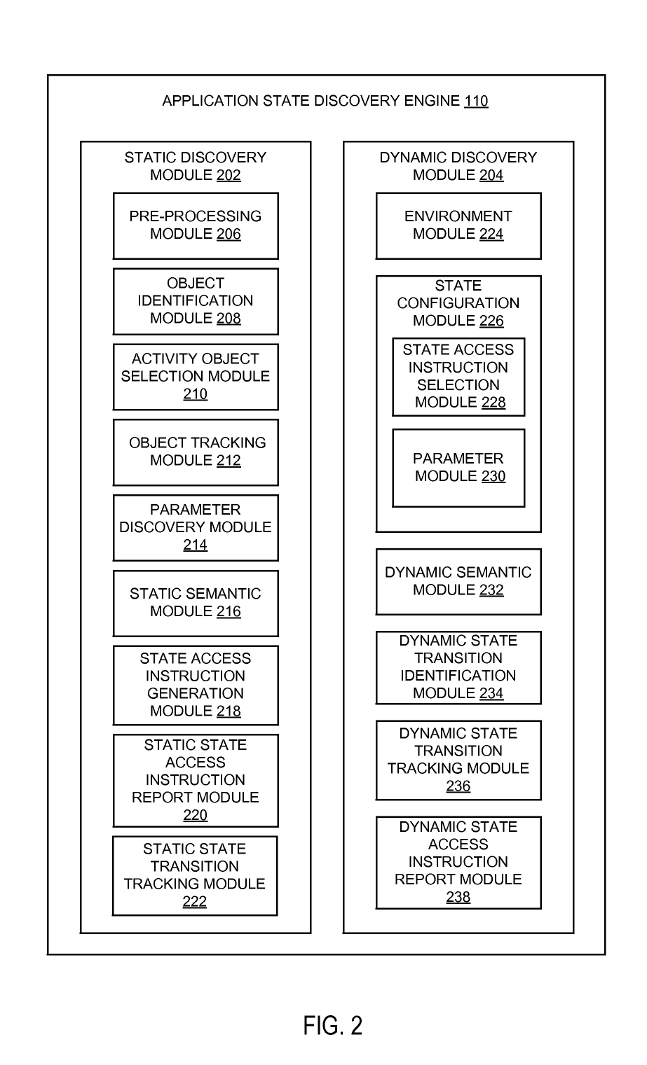

FIG. 2 is an illustration of an example application state discovery engine 110 in some embodiments. The application state discovery engine 110 may comprise a static discovery module 202 and a dynamic discovery module 204. In various embodiments, the static discovery module 202 may discover application states of an application by inspecting all or some code of the application. For example, an application developer may provide source code or any other code which may be inspected and/or scanned for information indicative of an application state or application state change.

In another example, the static discovery module 202 may decompile and/or perform other pre-processing of an application to generate a reviewable code which may be subsequently inspected and/or scanned. The following are examples of application state discovery in pre-processed code. It will be appreciated that the following examples and embodiments discussed herein is not limited to pre-processed code but may be any code including, for example, code that has not been decompiled and/or otherwise pre-processed (e.g., code provided by the application developer or otherwise obtained elsewhere).

In some embodiments, the static discovery module 202 may identify classes from the pre-processed code and scan functions related to the classes to identify either creation or passage of an activity object (e.g., an intent object). The activity object may be created by the pre-processed code or received from another source (e.g., operating system, another application, and/or another device). The static discovery module 202 may track variables associated with the activity objects including, for example, how they are assigned or used. A variable may reference a stored value. The static discovery module 202 may identify parameter variables from the tracked variables. A parameter variable is a variable that is utilized by the activity function to configure the application into another (or desired) state. The static discovery module 202 may generate a state access instruction based on the identified activity object and related parameter variable(s) (if any).

The static discovery module 202 may comprise a pre-processing module 206, an object identification module 208, an activity object selection module 210, an object tracking module 212, a parameter discovery module 214, a static semantic module 216, a state access instruction generation module 218, a static state access instruction report module 220, and a static state transition tracking module 222.

The pre-processing module 206 may be configured to pre-process an application code to a reviewable code. The reviewable code may be in any language. In some embodiments, the pre-processing module 206 decompiles and/or performs other pre-processing of the application code to generate a reviewable code that is machine readable. The reviewable code may be human readable and/or machine readable. For example, the reviewable code may be coded in the java programming language and/or XML. The pre-processing module 206 may be or include any decompiler, translator, parser, and/or the like.

In some embodiments, the pre-processing module 206 may decompress, extract, and/or separate code. For example, the pre-processing module 206 may disassemble and extract components from an ANDROID application package (APK). The APK is a package file format used to distribute and install application software onto a digital device with an ANDROID operating system. To make an APK file, an application for ANDROID is first compiled and then its parts are packaged into the file. The APK may contain all of the program's code (such as .dex files), resources, assets, and the manifest file. An APK file is a type of archive file.

The pre-processing module 206 may decompress some or all of an application. For example, the pre-processing module 206 may decompress some or all of an APK file (e.g., decompress the APK file). The pre-processing module 206 may extract the desired program's code (e.g., extract the .dex files from the decompressed APK package).

In various embodiments, the pre-processing module 206 decompiles the program's decompressed and/or extracted code into the reviewable format. The pre-processing module 206 may further parse the code for further analysis. For example, the pre-processing module 206 may segment and/or otherwise separate the code to enable scanning or pattern matching (e.g., to identify desired activity objects).

The object identification module 208 and/or the activity object selection module 210 may identify activity objects and/or candidate activity objects from the reviewable code. An activity object is an object identified in the reviewable code that is used to change the application state (e.g., reconfigure) the application. In various embodiments, an activity object is an object that reconfigures the application to an application state that enables access to or display of content. A candidate activity object may be an object identified in the reviewable code but has not yet been determined if the identified object changes the application state of the application and/or if the identified object reconfigures the application to an application state that enables access to or display of content. It will be appreciated that there may be any number of activity objects that do not change the application state of the application or changes the application state of the application in a manner that does not lead to valuable content and/or functionality.

In some embodiments, the object identification module 208 may identify classes within the reviewable code to identify creation of a candidate activity object. The object identification module 208 may, in some embodiments, identify candidate activity objects that are to be received by the application through inspection of the reviewable code.

In various embodiments, the object identification module 208 may utilize pattern matching (e.g., syntactic pattern matching) to identify patterns of code segments that serve as entry and exit points to functions performed by the applications. For example, the object identification module 208 may identify activity objects and/or candidate activity objects based on patterns such as API calls, usage of components, and/or other functionality. In one example, a pattern may identify and/or isolate one or more functions which may be public (e.g., publicly exposed triggers to activate) and/or private.

In some embodiments, the object identification module 208 may retrieve pattern matching rules from the data store 114. The object identification module 208 may scan the reviewable code to identify code (e.g., including references to candidate activity objects) that matches one or more of the pattern matching rules in order to identify an activity object. In one example, one or more pattern matching rules may identify API calls in general (or specific API calls) and/or usage of components.

For example, the object identification module 208 may perform forward or backward analysis. In forward analysis, the object identification module 208 may initiate a process where a starting point for a pattern (e.g., the beginning of a process that may change the application state of the application) is recognized in the reviewable code (e.g., identifying a candidate activity object, an API call, or other functionality). The object identification module 208 may subsequently scan and/or review the reviewable code for other functionality that further matches the pattern until the pattern is matched. Once the pattern is matched, the activity object selection module 210 may identify the activity object and any parameter variables used in changing the application state.

In backward analysis, the object identification module 208 may start with an exit point (e.g., the ending of a process that changes the application state of the application) for a pattern that is recognized in the reviewable code. The object identification module 208 may subsequently scan and/or review the reviewable code for other functionality that further matches the pattern until the pattern is matched. As similarly discussed regarding forward analysis, once the pattern is matched, the activity object selection module 210 may identify the activity object and any parameter variables used in changing the application state.

In various embodiments, the object identification module 208 and/or the activity object selection module 210 may determine (e.g., using pattern matching) which activity objects change the application state of the application to a configuration that enables display of or otherwise provides content or functionality. The object identification module 208 and/or the activity object selection module 210 may ignore or otherwise filter out activity objects that do not change the application state of the application. Similarly, the object identification module 208 and/or the activity object selection module 210 may ignore of otherwise filter activity objects that change the application state of the application to a state that does not provide or enable providing content and/or functionality.

Although the object identification module 208 and/or the activity object selection module 210 are discussed herein as selecting activity objects and/or identifying candidate activity objects from the reviewable code, it will be appreciated that the activity objects may be selected and/or candidate activity objects identified in any number of ways. In various embodiments, the object identification module 208 and/or the activity object selection module 210 may utilize any function, formula, or the like to select activity objects and/or consider candidate activity objects. In some embodiments, a person may select any number of activity objects and/or identify candidate activity objects through review of the reviewable code.

The object tracking module 212 and the parameter discovery module 214 may be configured to identify parameter variables that are used by the activity objects to configure the application to another application state. In various embodiments, once an activity object is identified and/or selected, the object tracking module 212 may track the use of parameter variables (e.g., any variables) that are created and/or used by the activity object. The object tracking module 212 may trace the use of parameter variables in the reviewable code by the activity object to determine the functions of the activity object, the type of parameter variables, how the parameter values are used, and the effect of the parameter values.

In one example, the object tracking module 212 may review the reviewable code to track variables that the activity object stores in memory (e.g., in a memory register). The object tracking module 212 may track the variables stored in memory and how the variables impact functionality. For example, the reviewable code may indicate that the activity object stores a parameter variable in a particular memory register. The object tracking module 212 may track how that memory register is to be used in the reviewable code. The object tracking module 212 may, for example, review the reviewable code to determine if the contents of the particular memory register are overwritten, the subject of mathematical functions, copied, used in other objects, or the like. By tracing the use of the variables of an activity object in the reviewable code, the object tracking module 212 and/or the parameter discovery module 214 may determine which variables are needed by the activity object to transition the application state of the application (e.g., which variables are parameter variables used with or by the activity object to transition to a new application state).

In various embodiments, the parameter discovery module 214 may identify any number of parameter variables that the reviewable code indicates are used by the activity object to configured the application to an application state. The parameter discovery module 214 may, based on the tracking of the object tracking module 212, identify any number of parameter variables.

The static semantic module 216 may be configured to discover semantic information (e.g., meanings, categories, labels, and/or the like) of the function of an activity object and/or any related parameter variables. In various embodiments, the static semantic module 216 may scan the reviewable code and/or utilize information from the object identification module 208, the object tracking module 212, and/or the parameter discovery module 214 to provide semantic information associated with the activity object and/or parameter variables.

For example, the static semantic module 216 may scan the reviewable code to determine how an activity object is used and the functions that the activity object performs. The static semantic module 216 may, based on the reviewable code, provide a description describing any number of functions and/or results associated with the activity object. In one example, the static semantic module 216 may utilize semantic rules (e.g., retrieved from the data store 114). The static semantic module 216 may compare the function and/or output of an activity object to conditions indicated by one or more of the semantic rules. The semantic rules that identify any number of descriptions or identifiers that provide semantic meaning to those activity objects with functions and/or output that meets the conditions identified by the semantic rule(s).

In various embodiments, the static semantic module 216 may summarize or otherwise provide information regarding functions and/or output of any number of activity objects to a user (e.g., administrator), another application, or operating system to enable semantic meaning regarding the activity function to be assigned, characterized, and/or provided.

In some embodiments, semantic meaning of the activity object and any parameter variables may allow for efficient storage and retrieval of information from the knowledge system 104. For example, the semantic meaning of output or functionality of an activity object allow for the activity object, associated parameter value(s), instructions indicating the activity object and associated parameter value(s), to be associated with and stored in the knowledge system 104. In some embodiments, the static semantic module 216 may identify semantic meaning and/or attributes associated with semantic meaning based on how the activity object is defined or usage of parameter values, functionality, and/or output indicated in the reviewable code. The static semantic module 216 may associate descriptions, identifiers, or the like (e.g., semantic meaning) with any number of categories such as tags. The categories may be associated with or similar to categories utilized in the knowledge system 104 or any data store (e.g., search system described herein).

The static semantic module 216 may summarize or otherwise provide information regarding any number of parameter variables to a user (e.g., administrator), another application, or operating system to enable semantic meaning of the parameter variables to be assigned, characterized, and/or provided.

In some embodiments, the semantic meaning of parameter variables are associated with and stored in the knowledge system 104. The static semantic module 216 may associate descriptions, identifiers, or the like (e.g., semantic meaning of parameter variables) with any number of categories such as tags. The categories may be associated with or similar to categories utilized in the knowledge system 104.

The static semantic module 216 may identify parameter values associated with parameter variables from the reviewable code. In some embodiments, the static semantic module 216 may review or scan the reviewable code for parameter values or indications of parameter values associated with the parameter variables. The static semantic module 216 may, for example, identify parameter values or at least attributes of parameter values based on definitions of parameter variables (e.g., integers, strings, or the like) and/or use of parameter variables. Further, the static semantic module 216 may identify parameter values based on indications of the reviewable code of use of parameter values and functionality of the associated activity object.

The state access instruction generation module 218 may be configured to generate state access instructions based on the activity object identified by the object identification module 208 and/or the activity object selection module 210. Further, the state access instruction generation module 218 may generate the state access instructions based on any parameter variables identified by the parameter discovery module 214 that is associated with the activity object.

The state access instruction generation module 218 may generate state access instructions including, but not limited to template function. As discussed herein, a template function instruction is an instruction that indicates the activity object (e.g., an application resource identifier) and includes associated parameter variables (if any). The template function instruction may be machine readable code. In some embodiments, the parameter variables are associated with any number of parameter values. For example, the parameter variables may indicate or be associated with a set of parameter values such as a set of parameter values maintained by the knowledge system 104 or other system. In some embodiments, the parameter variables are not associated with any parameter values. Parameter variables may be associated with parameter values at any time (e.g., by the application state discovery engine 110, an administrator, an application, another device, or the like).

The state access instruction generation module 218 may generate state access instructions that include references to the activity object (e.g., the application resource identifier) and any associate parameter values (i.e., not parameter variables).

The state access instruction generation module 218 may generate state access instructions in any format or language. In some embodiments, the state access instruction generation module 218 generates each state access instruction in a language and/or in a format that is understandable by an application.

In various embodiments, a state access instruction generated by the state access instruction generation module 218 may be used to configure an application to a particular application state. The application may, as a result of being configured to the particular application state, provide content or other functionality.

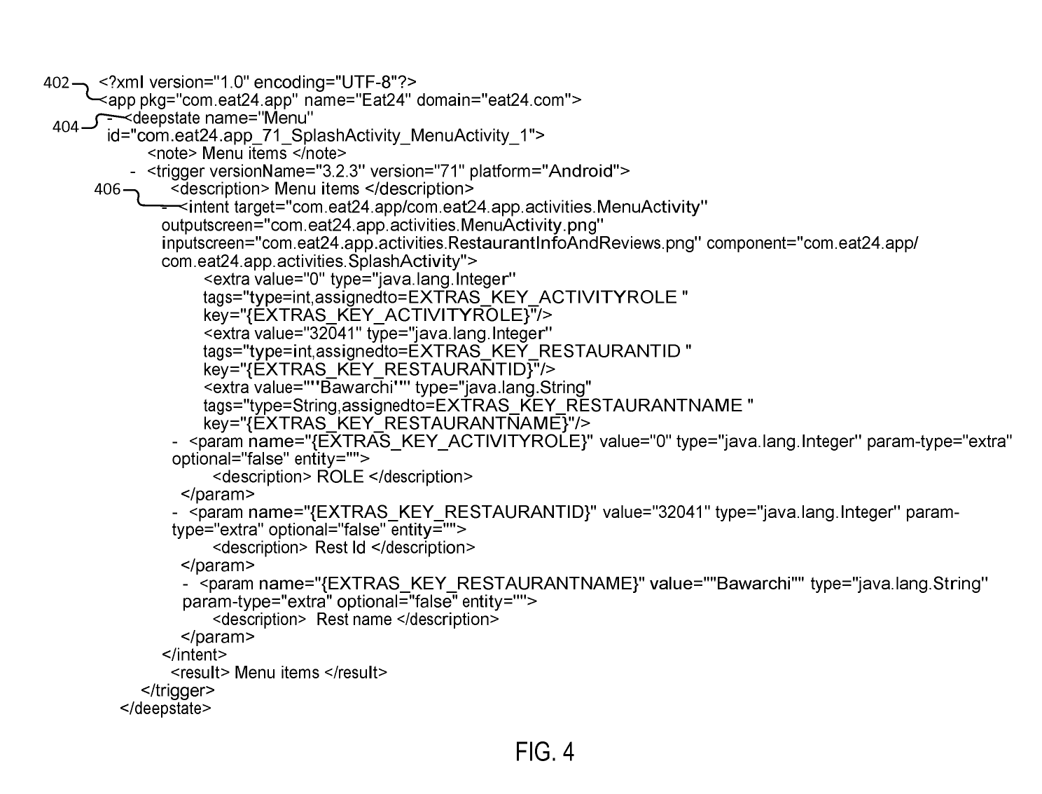

The static state access instruction report module 220 may generate a state access instruction report including any number of state access instructions provided by the state access instruction generation module 218. The static state access instruction report may include a list of state access instructions. In one example, the static state access instruction report may include one or more template function instructions having application resource identifiers and/or parameter variables. In another example, the static state access instruction report may include one or more state access instructions having application resource identifiers and/or parameter values. The static state access instruction report may be formatted in XML. An example portion of a static application state instruction report is depicted in FIG. 4 which is further discussed herein.

The static state transition tracking module 222 may be configured to track which application state associated with state access instructions are accessible (e.g., without privileges). For example, as discussed herein, a manifest file may indicate published, available intents that may be used to configure an application to a particular application state. The intents identified by the manifest file may configure the application without requiring privileges (e.g., the state of the application is directly accessible without privileges). Other application states (e.g., other intents) may not be accessed without privileges unless manually navigating the application. For example, an application may require privileges or other requirements before allowing the application to be reconfigured using a state access instruction.

In various embodiments, the static state transition tracking module 222 may review the reviewable code (e.g., including the function of activity objects and/or parameter variables in the reviewable code) to determine which application states are accessible without privileges (e.g., determining if privileges are required to execute a class, activity object, activity object functionality, and/or parameter variables). If a state access instruction is associated with an application state that is not accessible without privileges, then the static state transition tracking module 222 may flag the state access instruction with an indication that the associated state may not be directly accessed.

The dynamic discovery module 204 may execute the application to enable identification of semantic meaning for activity objects and/or parameter variables. In one example, a state access instruction may be utilized to configure an application to a particular application state. The application may, once configured, provide an output interface including content. The content may, in some examples, be from the application, retrieved by the application locally to display in the output interface, or received from another source (e.g., an application server such as application server 106-1). A user and/or the dynamic discovery module 204 may associate the state, activity object, state access instructions and/or the like with semantic meaning based, in part, on the output interface and/or content of the output interface. Similarly, a user and/or the dynamic discovery module 204 may, in some examples, associate parameter variables and/or parameter values with semantic meaning based on the application, application usage, output interface, and/or content.

In some embodiments, the dynamic discovery module 204 may execute the application to identify previously undiscovered application states and/or identify activity objects. In one example, an administrator or another application (e.g., automated function) may navigate the application to achieve different application states. The dynamic discovery module 204 may monitor commands, the operation of the application, and parameters. If a new application state is identified, the dynamic discovery module 204 may generate a state access instruction (e.g., template) associated with the new application state. The state access instruction may be included within or added to a state access instruction report as previously discussed herein.

The dynamic discovery module 204 may comprise an environment module 224, a state configuration module 226, a dynamic semantic module 232, a dynamic state transition identification module 234, a dynamic state transition tracking module 236, and a dynamic state access instruction report module 238. The state configuration module 226 may comprise a state access instruction selection module 228 and a parameter module 230.

The environment module 224 may create, provision, and/or enable an environment to run the application. In some embodiments, the environment module 224 may provide emulation and/or virtualization. In various embodiments, the environment module 224 may provide an environment without emulation or virtualization (e.g., a digital device running an operating system such as a mobile device running the ANDROID OS).

In various embodiments, the environment module 224 is configured to run and monitor the application in an emulated environment whereby mobile device hardware is simulated in software. For example, the application may run in the emulated environment as if the application was on a mobile device (e.g., running the ANDROID OS). The emulated environment may allow the application to have direct memory access (e.g., a bare metal environment). The behavior of the application may be monitored and/or tracked to track function operations and data stored in memory (e.g., track application behavior including memory registers, functions, APIs, and the like). For example, the emulated environment may track what resources (e.g., applications and/or operating system files) are called in processing by the application as well as what data is stored.

In some embodiments, the environment module 224 may be configured to run and monitor the application in a virtualization whereby some parts of the mobile device hardware may be simulated. The virtualization may track application behavior including memory registers, functions, APIs, and the like. For example, the virtualization environment may track what resources (e.g., applications and/or operating system files) are called in processing by the application as well as what data is stored.

In various embodiments, a single digital device may run in any number of virtualized environments as if each application was on a mobile device. The application may be instantiated in each environment. A different state access instruction may be utilized to configure the application to different application states in different environments (e.g., in parallel) thereby achieving scalability. Similarly, any number of emulated environments may be created. The application may be instantiated in each environment and different state access instructions utilized to configured the application to different states in parallel. Further, in some embodiments, the same application may be instantiated in both emulation and virtualization environments.

The state configuration module 226 may configure the application within the environment to an application state. For example, the state configuration module 226 may provide or execute a state access instruction (e.g., a template function instruction) to configure the application to the desired application state. The application may be configured and subsequently generate, in one example, an output interface that may display content, indicate functionality, or the like. In some embodiments, the application may retrieve content from any source such as a remote server (e.g., application server 106-1) to display in the output interface. It will be appreciated that content provided by an application at a particular application state may be unknown based on the reviewable code. By running and configuring the application to a particular application state in an environment (e.g., provided by the environment module 224), the application state, related activity object, parameter variables, parameter values, content, and/or the like may be better understood. As a result, the application state, related activity object, parameter variables, parameter values, content, and/or the like may be better described (e.g., associated with categories and/or tags based on semantic meaning).

The state configuration module 226 may include a state access instruction selection module 228 and a parameter module 230. The state access instruction selection module 228 may retrieve a state access instruction report and/or a state access instruction from the state access instruction report (e.g., generated or otherwise provided by the static discovery module 202) to configure the application in the environment. The state access instruction selection module 228 may utilize any number of the state access instructions and/or select any or all of the state access instructions in any order.

Once a state access instruction is selected by the state access instruction selection module 228, the parameter module 230 may retrieve and/or provide any values associated with any parameter variables indicated by the state access instruction. For example, the parameter module 230 may receive semantic information, categories (e.g., tags) or the like associating one or more parameter variables with one or more parameter values (e.g., any of a set of parameter values stored in the knowledge system 104). The parameter module 230 may provide any number of parameter values to the state access instruction, the application, environment, or the like to assist in configuration of the application.

For example, the state access instruction may include instructions to configure an application to provide restaurant reviews. The parameter module 230 may identify a parameter variable of the state access instruction and retrieve one or more parameter values (e.g., zip codes) from the knowledge system 104 to provide to the application with the instructions. Subsequently, the application may be configured to provide restaurant reviews for the zip code provided by the parameter module 230.

The dynamic semantic module 232 may be configured to discover semantic information (e.g., meanings, categories, labels, and/or the like) of the function of an activity object and/or any related parameter variables from the dynamic environment. The dynamic semantic module 232 may provide semantic information associated with the activity object, parameter variables, state access instruction, output interface, parameter values, or the like.

For example, the dynamic semantic module 232 may scan an output interface provided by the application that is configured to a particular application state. The dynamic semantic module 232 may, based on content of the output interface, provide a description describing any number of functions and/or results associated with the application state. In one example, the dynamic semantic module 232 may utilize semantic rules (e.g., retrieved from the data store 114). The dynamic semantic module 232 may compare the function and/or output of the application to conditions indicated by one or more of the semantic rules. The semantic rules that identify any number of descriptions or identifiers that provide semantic meaning to those states or related activity object, parameter variables, state access instruction, output interface, and/or parameter values.

In some embodiments, the dynamic semantic module 232 may collect or identify a subset of parameter values (e.g., a seven digit number) which may indicate the type of information needed to transition application states. For example, the dynamic semantic module 232 may indicate or display a sample parameter value to a user who can assign a description or describe the meaning of the sample parameter value (e.g., the user assigns the tag “zip code” to the parameter variable and/or value based on the sample).

In various embodiments, the dynamic semantic module 232 may receive semantic information from a user such as an administrator. For example, the application may be display an output interface to the user. The user may provide the dynamic semantic module 232 with any indication, meanings, descriptions, identifiers, or the like to provide semantic meaning. In some embodiments, the administrator may further provide information associating the semantic meaning with categories of the knowledge system 104. The dynamic semantic module 232 may associate or store state access instructions, state access instruction reports, parameter variables, parameter values, and/or the like in the knowledge system 104.

As discussed herein, semantic meaning of the activity object and any parameter variables may allow for efficient storage and retrieval of information from the knowledge system 104. For example, the semantic meaning of output or functionality of an activity object allow for the activity object, associated parameter value(s), instructions indicating the activity object and associated parameter variable(s), are associated with and stored in the knowledge system 104. The dynamic semantic module 232 may associate descriptions, identifiers, or the like (e.g., semantic meaning) with any number of categories such as tags. The categories may be associated with or similar to categories utilized in the knowledge system 104.

The dynamic semantic module 232 may summarize or otherwise provide information regarding any number of parameter variables to a user (e.g., administrator), another application, or operating system to enable semantic meaning of the parameter variables to be assigned, characterized, and/or provided.

In some embodiments, the semantic meaning of parameter variables are associated with and stored in the knowledge system 104. The dynamic semantic module 232 may associate descriptions, identifiers, or the like (e.g., semantic meaning of parameter variables) with any number of categories such as tags. The categories may be associated with or similar to categories utilized in the knowledge system 104.

The dynamic state transition identification module 234 may identify new application states based on execution, configuration, and reconfiguration of an application in the environment. In some embodiments, the environment enables a user to interact with an application. The interaction may configure the application to reach a new, previously unpublished, application state. It will be appreciated that the dynamic state transition identification module 234 may track and identify function calls, activity objects, parameter variables, parameter values, and/or the like. The dynamic state transition identification module 234 may track activity objects, parameter variables, and/or parameter values associated with the configuring the application to the application state. Subsequently, the dynamic state transition identification module 234 may generate and/or store a state access instruction that may be utilized to return the application to the previously undiscovered application state. The dynamic state transition identification module 234 may include the new state access instruction in the state access instruction report.

In various embodiments, the dynamic state transition identification module 234 may inspect execution of code in runtime. In some embodiments, the dynamic state transition identification module 234 may hook various APIs, collect parameters, and/or collect interprocess communication messages to identify new application states and provide context for application states, parameters, and/or the like. The dynamic state transition identification module 234 may perform application level and/or operating system level hooking. In some embodiments, the dynamic state transition identification module 234 may identify an object passing into the application. The dynamic state transition identification module 234 may analyze the object and context to better understand the object.

The dynamic state transition tracking module 236, similar to the static state transition tracking module 222, may be configured to track which application state associated with state access instructions are accessible (e.g., without privileges) and which may be indirectly accessible (e.g., manual navigation of the application and/or having privileges). Application states that may be directly accessed (e.g., using a state access instruction, the application may be configured to a particular application state without privileges) or indirectly accessed (e.g., requiring operating system privileges or navigation of the application in a manner that may be similar to a user). In various embodiments, the dynamic state transition tracking module 236 tracks and/or provides an indication whether any number of state access instructions of the state access instruction report allow for direct access to an application state or allow for indirect access to the application state. The dynamic state transition tracking module 236 may track and/or determine if an application state associated with an activity object is directly accessible or indirectly accessible based on the execution, configuration, and reconfiguration of the application.

The dynamic state access instruction report module 238 may be configured to generate access instructions (e.g., for a previously undiscovered application state that is discovered while the application is executed in the environment) and/or provide any additional information in the state access instruction report. In one example, the dynamic application state instruction report module 238 associates parameter variables of state access applications with parameter values of the knowledge system 104 and stores the association (e.g., stores links between the parameter variable and the parameter values of the knowledge system 104) in the state access instruction report.

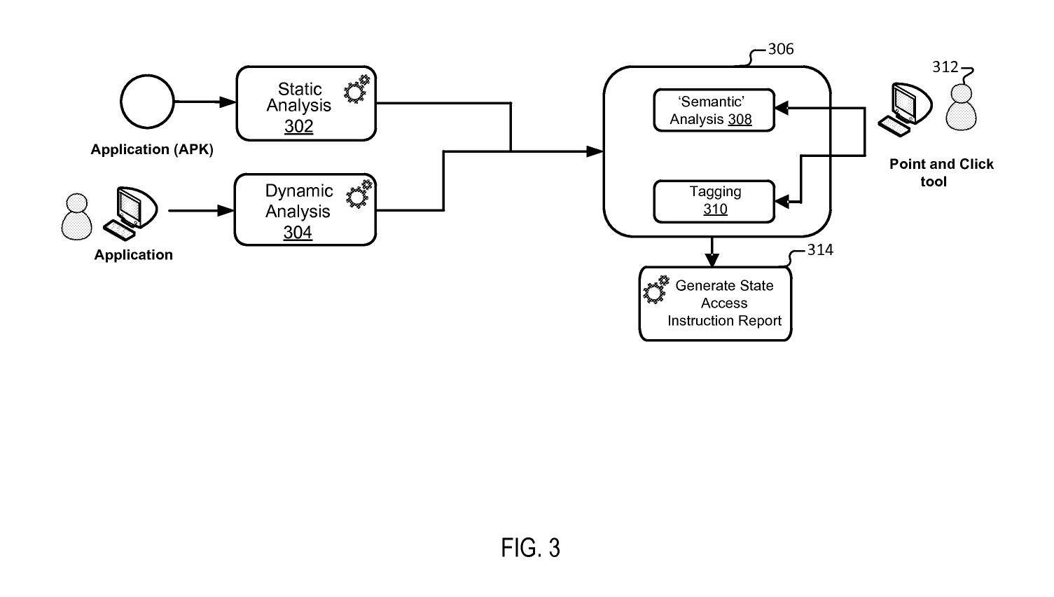

FIG. 3 is a diagram of the generation of the state access instruction report and semantic meaning in some embodiments. In FIG. 3, static analysis 302 may be performed on an application APK. As discussed herein, static analysis 302 may comprise pre-processing (e.g., decompiling, decompressing, parsing, and/or the like) all or some of the APK (e.g., dex files of the APK) to a reviewable code. The reviewable code may also be machine readable code. During static analysis 302, the code may be reviewed for activity objects (e.g., intents) that may configure the application to an application state. The state and/or activity object may not have been previously published by the application developer (e.g., the application state and/or activity object may not have been indicated in the Application's manifest file).

Subsequently or in parallel with the static analysis 302, a dynamic analysis 304 may be performed on the application. For example, an emulated environment may be created and an instance of the application instantiated. Since the environment is emulated, the application may perform as if the application was installed on a mobile device. Further, the emulated environment may monitor interactions with hardware, memory registers, and the like. As a result, the emulated environment may identify instructions and/or parameter values that configure the application to a previously undisclosed state.

Determining meaning (e.g., description or assignment of identifiers such as tags) 306 may include semantic analysis 308 and/tagging 310. In various embodiments, an administrator 312 or other user may view output (e.g., an output interface) from the application in the dynamic analysis 304 and provide semantic meaning associated with the application state, activity objects called to obtain the application state, parameter variables, example parameter values, content, and/or the like. The administrator 312 or any other entity (e.g., application, server, device, or the like) may associate the application state, activity objects called to obtain the application state, parameter variables, example parameter values, content, and/or the like with categories or tags 310. In some embodiments, the categories or tags 310 are associated with the knowledge system 104.

In some embodiments, the administrator 312 or other user may view the reviewable code in the static analysis 302 and provide semantic meaning associated with the application state, activity objects called to obtain the application state, parameter variables, example parameter values, content, and/or the like as similarly discussed regarding the dynamic analysis 304. The administrator 312 or any other entity (e.g., application, server, device, or the like) may associate the state, activity objects called to obtain the application state, parameter variables, example parameter values, content, and/or the like with categories or tags 310.

State access instructions may be created and/or stored in a state access instruction report 314. The state access instructions may include activity objects and/or parameter variables (or parameter values) as determined in the static analysis 302 and/or the dynamic analysis 304. The state access instructions may include the tags 310 (e.g., parameter variables that correspond to parameter values such as those that may be stored in the knowledge system 104).

FIG. 4 is a portion of a state access instruction report in some embodiments. The state access instruction report may be in any language and/or in any format. The portion of the state access instruction report as shown in FIG. 4 is in XML. The application name 402 identifies an application package. In some embodiments, any number of the state access instructions of the state access instruction report may be utilized to change the application state of the application identified by the application name 402. The deepstate name 404 may identify the desired application state of the application to be reached with the state access instruction. The intent target 406 may indicate that activity object (e.g., function instructions) that may configure the application to the application state identified by deepstate name 404.

The parameters shown in FIG. 4 define and indicate parameter variables for the activity object to be called by the state access instruction. The parameters may indicate parameter values to be received from a user, from the knowledge system 104, and/or another application.

It will be appreciated that the state access instruction report may have any number of state access instructions.

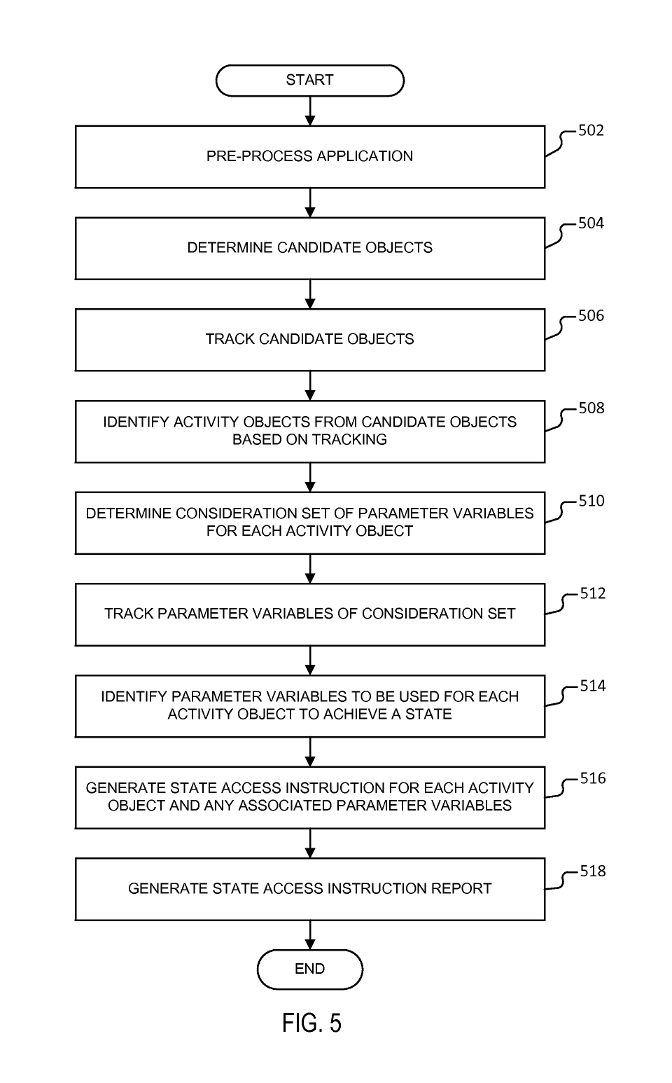

FIG. 5 is a flowchart of an example method for discovering application states of an application. In step 502, the pre-processing module 206 of the static discovery module 202 may decompile an application. The application may be any application including, for example, an application executable on a mobile device. In some embodiments, the pre-processing module 206 decompiles, decompresses, parses, and/or the like the application code to a reviewable code. The reviewable code is code that may be reviewed by a user (e.g., administrator) and/or other module or other digital device.

In various embodiments, the pre-processing module 206 decompresses an application package, extracts the desired code (e.g., a subset of the package contents) from the package, and decompiles the extracted, desired code into reviewable code. The pre-processing module 206 may parse the decompiled code.

In step 504, the object identification module 208 determines candidate objects (e.g., candidate activity objects). A candidate object is any object that may change or assist in changing the application state of the application. It will be appreciated that the reviewable code of an object may indicate or suggest functionality that changes or assists in changing the application state of the application. In some embodiments, the object identification module 208 may scan the reviewable code to identify any number of candidate objects. In some embodiments, the object identification module 208 may compare an object from the reviewable code to any number of patterns and/or object templates that may indicate the desired functionality (e.g., changing or assisting in changing an application state) to identify the candidate objects.

In step 506, the object tracking module 212 may track the candidate objects in the reviewable code. For example, the activity object selection module 210 may select a candidate object of a set of candidate objects identified by the object identification module 208. The object tracking module 212 may track or trace the candidate object's functionality and the functionality of the application that affect the candidate object through the reviewable code.

In step 508, the object tracking module 212 may identify objects based on tracking. In some embodiments, the object tracking module 212 may retrieve or receive pattern matching rules (e.g., from the data store 114). The pattern matching rules may enable the object tracking module 212 to identify activity objects based on recognized patterns of code and/or functionality identified in the reviewable code.

It will be appreciated that there may be different pattern matching rules for different applications. For example, there may be pattern matching rules for a review application and different pattern matching rules for a recommendation application. A recommendation application may be an application that recommends business or services to a user based on criteria provided by the user, such as recommending restaurants, cleaning services, or the like. The object tracking module 212 may identify the application that will be or is pre-processed. The object tracking module 212 may subsequently retrieve pattern matching rules based on the identified application.

For example, the object tracking module 212 may initiate a process where a starting point for a pattern (e.g., the first function or activity associated with the candidate object) recognized in the reviewable code and subsequently scan and/or review the reviewable code for other functionality that further matches the pattern until the pattern is matched (i.e., forward matching). In another example, the object tracking module 212 may initiate a process with an exit point (e.g., the ending of a process that changes the application state of the application) and subsequently scan and/or review the reviewable code for other functionality that further matches the pattern until the pattern is matched (i.e., backward matching).

It will be appreciated that the object tracking module 212 may recognize or otherwise identify an activity object in any number of ways.

In step 510, the parameter discovery module 214 determines a consideration set of parameter variables for each activity object. For example, the object tracking module 212 may identify an activity object based on object tracing using the reviewable code. The parameter discovery module 214 may identify all parameter variables that may be used by the activity object (e.g., including those parameter variables in the activity object definition) that may be used to change or assist in changing the application state of the application.

In various embodiments, the parameter discovery module 214 may identify parameter variables to add to the consideration set of parameter variables. The parameter discovery module 214 may include any number of variables created or used by the activity object as indicated in the reviewable code. The parameter discovery module 214 may also include any number of variables that may affect the functionality of the activity object as indicated in the reviewable code.

In step 512, the parameter discovery module 214 may track variables of the consideration set to identify parameter variables. For example, the parameter discovery module 214 may trace the function and use of each variable in the reviewable code to identify those variables (i.e., parameter variables) that may be used by or with the activity object to change the application state of the application.

In step 514, the parameter discovery module 214 identifies parameter variables to be used by or with each activity object to change the application to different application states. In one example, the parameter discovery module 214 identifies parameter variables based on the tracking of variables of the consideration set.

In step 516, the state access instruction generation module 218 may generate one or more state access instruction(s) for each activity object and any associated parameter variables. For example, the state access instruction generation module 218 may generate a state access instruction identifying the activity object and parameter variables identified by the parameter discovery module 214. In one example, the state access instruction may be template state instruction that may be used to configure or assist in the configuration of an application to a new state.

The template state instruction may include an identification (or call) of the activity object (e.g., an application resource identifier) and the parameter variable(s) (if any). The parameter variables may refer to values (e.g., parameter values) that may be stored (e.g., in the knowledge system 104, by the application, another data store, another application, or remotely). In various embodiments, the state access instruction (e.g., template state instruction) may be stored (e.g., in the knowledge system).

In step 518, the static state access instruction report module 220 may generate a report including any or all of the state access instruction(s) from the state access instruction generation module 218.

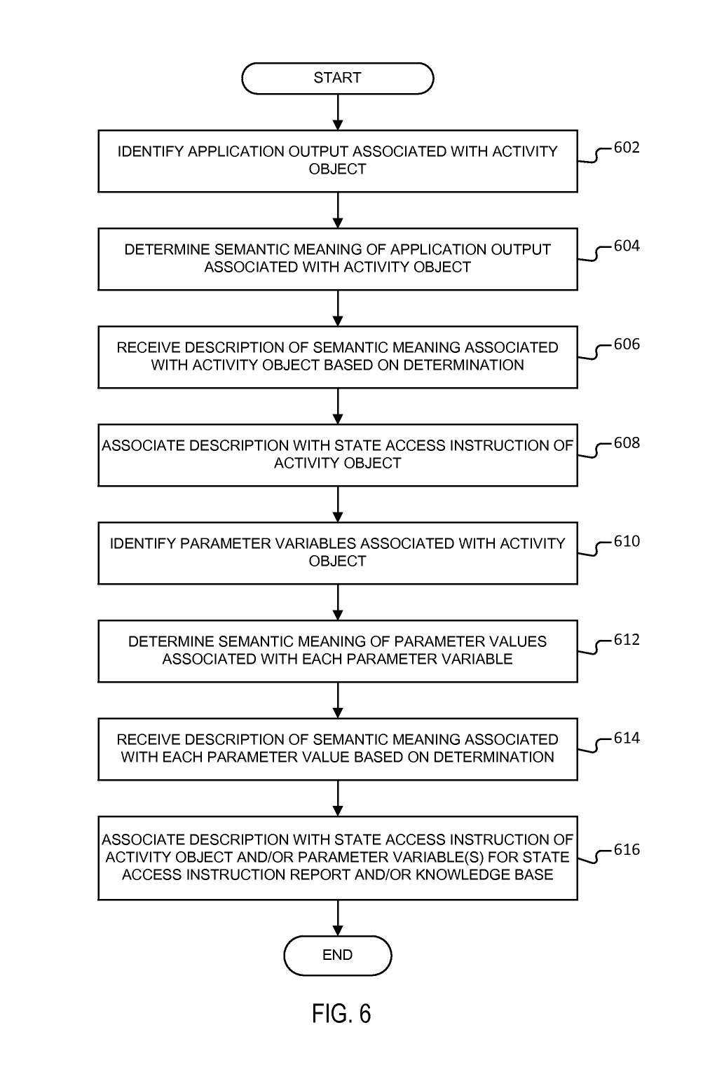

FIG. 6 is a flowchart of an example method for identifying semantic meaning associated with an activity object and associated parameter variables (if any) in some embodiments. In step 602, the static semantic module 216 may identify application output (e.g., an output interface or contents that may appear in an output interface as identified by the reviewable code) associated with the activity object. For example, the static semantic module 216 may review the reviewable code to identify an indication of a change of state caused by or related to an activity object. Based on review of the reviewable code, the static semantic module 216 may identify the output of the application when the application is configured to reach the desired application state.

In step 604, the static semantic module 216 determines semantic meaning of the application output associated with the activity object. In various embodiments, the static semantic module 216 may receive or retrieve semantic rules (e.g., from the data store 114). The semantic rules may provide associations between one or more portions (e.g., elements and/or functions) of reviewable code and predetermined meanings. For example, the semantic rules may associate portions of code used to generate, receive, or provide names of eating establishments with a semantic meaning (e.g., “restaurants”).

It will be appreciated that the application state discovery engine 110 may include or be associated with a machine learning module configured to learn associations of portions of reviewable code and meaning. In some embodiments, a machine learning module may be configured to scan or review the reviewable code to identify semantic meaning. The machine learning module may also be trained using predetermined associations.

In step 606, the static semantic module 216 may receive a description of semantic meaning associated with the activity object based on the determination. In various embodiments, an administrator or another application may receive or identify an activity object from the reviewable code and indications of output associated with the function of the activity object. The indications of output may also be indicated by the reviewable code. In some embodiments, the administrator may provide semantic meaning to the static semantic module 216.

It will be appreciated that the semantic meaning may be determined and/or received in any number of ways. Further, semantic meaning maybe provided by any number of administrators and/or automated. If output associated with an activity object receives different indications of meaning, the static semantic module 216 may provide the different meanings to an administrator or resolve the many meanings in any number of ways.

In step 608, the static semantic module 216 associates the description with a state access instruction of the activity object. In various embodiments, the static semantic module 216 may associate the description and/or categories associated with the description with a state access instruction. For example, the state access instruction generation module 218 may generate a state access instruction that identifies an activity object and any associated parameter variables that may be used to configure an application to a particular application state. Output associated with that particular application state may be characterized with semantic meaning (e.g., descriptions). The semantic meaning may further be categorized or tagged by the static semantic module 216. The static semantic module 216 may categorize the semantic meaning using categories that categorize content within the knowledge system 104.

In step 610, the static semantic module 216 identifies parameter variables associated with the activity object. As previously discussed, the state access instruction generation module 218 may generate a state access instruction that identifies an activity object and associated parameter variables that may be used to configure an application to a particular state. The reviewable code may provide indications of the semantic meaning of any number of parameter variables.

In step 612, the static semantic module 216 determines semantic meaning of parameter variables. In some embodiments, the static semantic module 216 identifies the meaning of parameter values associated with a parameter variable. The semantic meaning of the parameter values may then be associated with the parameter variable. For example, the static semantic module 216 may identify parameter values associated with the parameter variables. If the parameter values are, for example, zip codes, the static semantic module 216 may associate the semantic meaning “zip code” with the parameter variable.

In step 614, the static semantic module 216 may receive a description of semantic meaning associated with each parameter value based on the determination. In some embodiments, the static semantic module 216 may identify and/or provide indications of use of any number of variables in the reviewable code. A user, static semantic module 216, another application, and/or machine learning module may provide semantic meaning of any or all parameter variables associated with an activity object (e.g., based on the reviewable code and/or any information provided by the static semantic module 216). The semantic meaning of parameter variables may further be categorized or tagged by the static semantic module 216. The static semantic module 216 may categorize the semantic meaning of parameter variables using categories that categorize content within the knowledge system 104.

In step 616, the static semantic module 216 associates the description of the semantic meaning of any number of parameter variables with a state access instruction of the activity object. In various embodiments, the static semantic module 216 may associate the description and/or categories associated with the description of parameter variables with a state access instruction. As previously discussed, the state access instruction generation module 218 may generate a state access instruction that identifies an activity object and any associated parameter variables that may be used to configure an application to a particular state. Parameter variables and/or parameter values may be associated with semantic meaning. The semantic meaning may further be categorized or tagged by the static semantic module 216. The static semantic module 216 may categorize the semantic meaning using categories that categorize content within the knowledge system 104.

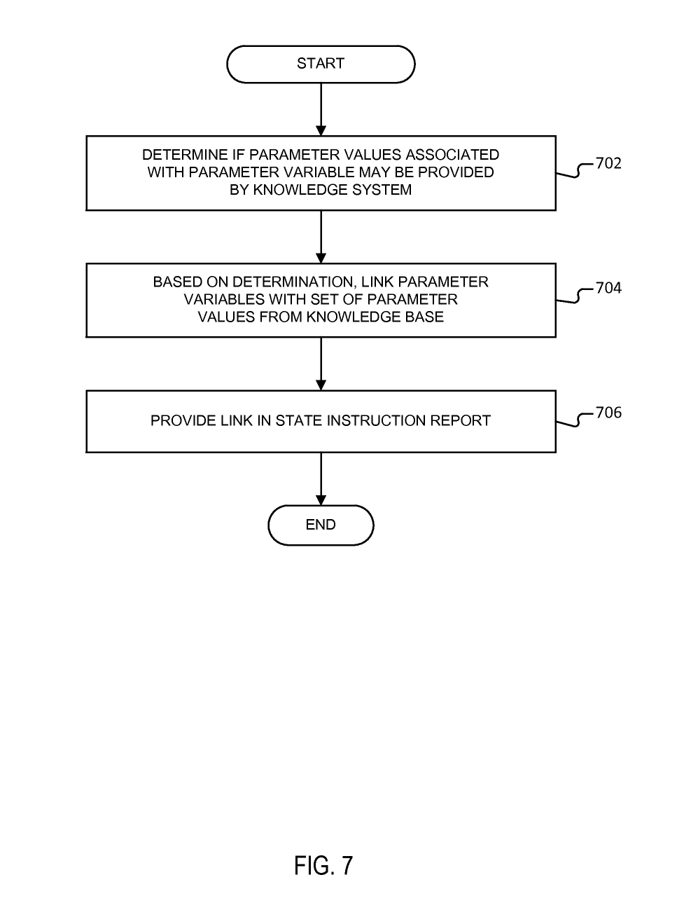

FIG. 7 is a flowchart of an example method for linking parameter values with parameter variables. In step 702, the parameter discovery module 214 may determine if one or more parameter values associated with a parameter variable may be provided by the knowledge system 104. In various embodiments, the parameter discovery module 214 may identify any number of parameter values in the reviewable code that are associated with parameter variables. The static semantic module 216 may provide or receive semantic meaning associated with the parameter variables based on the parameter values as discussed herein. Further, the static semantic module 216 may associate categories (e.g., tags) with parameter variables.

In various embodiments, the parameter discovery module 214 may, based on the categories, determine if there are previously stored parameter values that may be associated with the parameter variables. For example, if the parameter variables are variables for referring to zip codes, the parameter discovery module 214 may determine that the knowledge system 104 has a set of zip codes that may be parameter values for the parameter variable. It will be appreciated that any number of parameter values may be associated with any number of parameter variables. Similarly, parameter values from any source (e.g., data store, remote server, another local application, or the like) may be associated with parameter variables.

In step 704, the parameter discovery module 214 may link parameter variables with any number of a set of parameter values from the knowledge system 104. For example, once the parameter discovery module 214 determines a set of parameter values from the knowledge system 104 may be associated with a parameter variable in a state access instruction, the parameter discovery module 214 may modify the state access instruction or provide additional information to allow the parameter values in the knowledge system 104 to be used when changing the state of the application. It will be appreciated that any number of parameter values from different sources may be linked with any number of parameter variables.

In step 706, the parameter discovery module 214 may include the modified state access instruction in the state instruction report and/or in any memory (e.g., knowledge system 104).

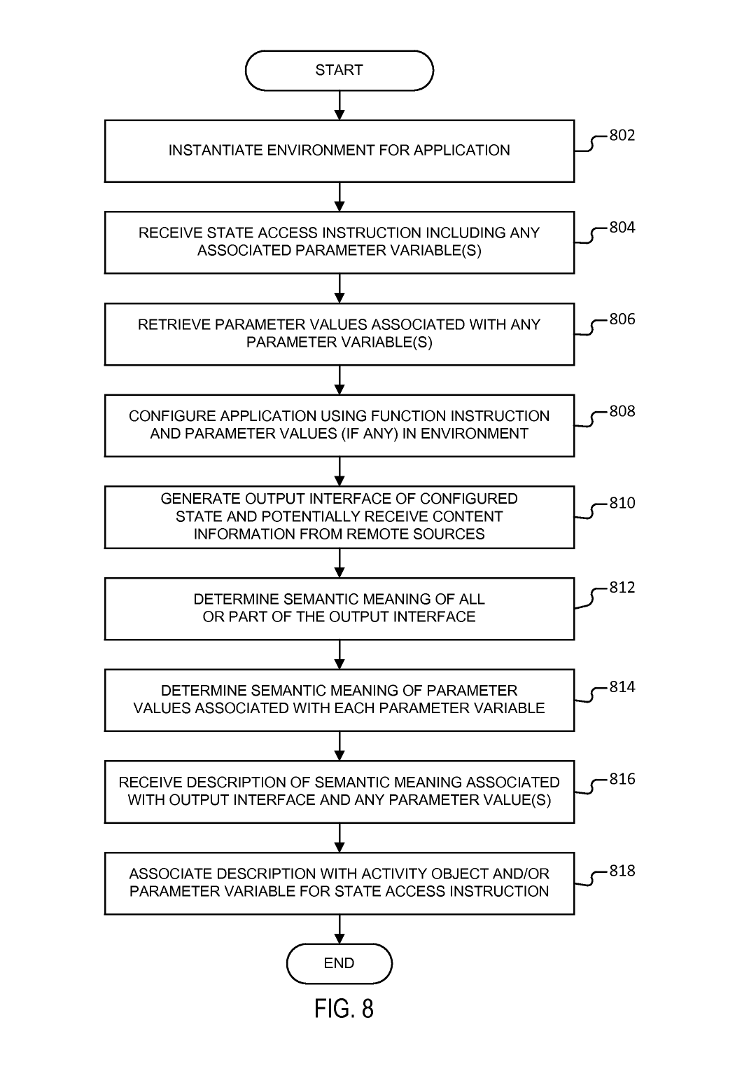

FIG. 8 is a flowchart of an example method for discovering states of an application in a dynamic environment. In step 802, the environment module 224 may instantiate an environment for the application. For example, the environment module 224 may instantiate an emulated environment or a virtualization.

In step 804, the environment module 224 and/or the state configuration module 226 may receive a state access instruction including references to activity objects and any associated parameter variables. In some embodiments, the state configuration module 226 may select state access instructions from a state access instruction report. The state access instruction and/or state access instruction report may be provided to the state configuration module 226 in any number of ways.

In step 806, the state configuration module 226 may retrieve parameter values associated with any parameter variables. The state access instruction received by the state configuration module 226 may include one or more parameter values rather than parameter variables. In some embodiments, the state access instruction may include a parameter variable with a link that is associated with parameter values contained in the knowledge system 104 or any source. The state configuration module 226 may retrieve any number of parameter values based on the link.

In step 808, the state configuration module 226 configures the application in the environment using the state access instruction and any linked parameter values associated with the state access instruction to generate an output interface. For example, the state configuration module 226 may control and configure the application in the environment using the state access instruction and any linked parameter values.

Once the application is configured by the state configuration module 226, the application may generate an output interface in step 810. The output interface may correspond to the state and may include UI elements and/or content. In various embodiments, the output interface may include information generated by application or retrieved from an external source (e.g., application server 106-1 or locally). It will be appreciated that inspection of the application code (e.g., the reviewable code of the application) may not indicate or suggest the information that may be received (e.g., downloaded) from other sources. As a result, in some embodiments, the dynamic discovery module 204 may configure the application in an environment to generate/receive information from those sources to allow for semantic meaning and description of functions and parameter values.

In step 812, the dynamic semantic module 232 may determine semantic meaning of all or part of the output interface. A user, the dynamic semantic module 232, and/or machine learning module may recognize the content generated or provided by all or part of the output interface. The user, the dynamic semantic module 232, and/or machine learning module may determine and/or characterize the content, layout, functionality, and/or the like of an output interface generated by the application.

In step 814, the dynamic semantic module 232 may determine semantic meaning of parameter values associated with each parameter variable used to configure an application to an application state. For example, the user, the dynamic semantic module 232, and/or machine learning module may recognize semantic meaning from a UI element requesting information to be used as a parameter variable (e.g., a field request for information). In another example, the user, the dynamic semantic module 232, and/or machine learning module may recognize semantic meaning of parameter variables from the output interface (e.g., requesting an area code), semantic meaning of activity objects (e.g., based on the output of the state associated with an activity object), and output of the state.

In step 816, the dynamic semantic module 232 may receive description (e.g., text, categories, tags, or the like) that describe the semantic meaning associated with output interface and any parameter value(s) and/or parameter variables. The description may be provided by any source including, but not limited to, the user, the dynamic semantic module 232, and/or machine learning module.

In step 818, the dynamic semantic module 232 may associate the description with the activity object and/or parameter variables of the state access instructions and/or state access instruction report. In various embodiments, the dynamic semantic module 232 may provide the description and the associated state access instruction to the knowledge system 104. In some embodiments, a user may provide a query. The knowledge system 104 or a search system may identify the state access instruction using the information from the query and the description. The description may be used in any number of ways.

In some embodiments, the state access instruction may include a subset of parameter values (e.g., discovered from static analysis of the reviewable code). The dynamic discovery module 204 may configure an application in an emulation environment using the state access instruction and any number of the values from the subset to generate an output interface. The dynamic semantic module 232, based on the output interface and/or any of the subset of parameter values, may allow for the determination of semantic meaning of the parameter variable(s).

In some embodiments, semantic meaning determined by the static discovery module 202 may be improved. For example, the static discovery module 202 may identify a preliminary semantic meaning of an activity object and/or parameter variables based on inspection of the reviewable code. The dynamic discovery module 204, by configuring an application to a particular state and generating the output interface related to that state, may provide an improved understanding of the activity object and/or parameter variables (e.g., from an administrator and/or the dynamic semantic module) thereby allowing for improved or additional semantic meaning. As a result, additional categorization and/or descriptions may be applied or associated with the related state access instruction.

Returning to the discussion regarding FIG. 1, the application exploration system 102 may include a scraper engine 112 configured to scrape content from one or more application states of an application. Scraping content from an application state may include identifying User Interface (UI) elements from an output interface resulting configuration of an application to an application state and scraping content from the UI elements. The scraped content may be stored and indexed in the knowledge system 104, for example, in the corpus data store 126.

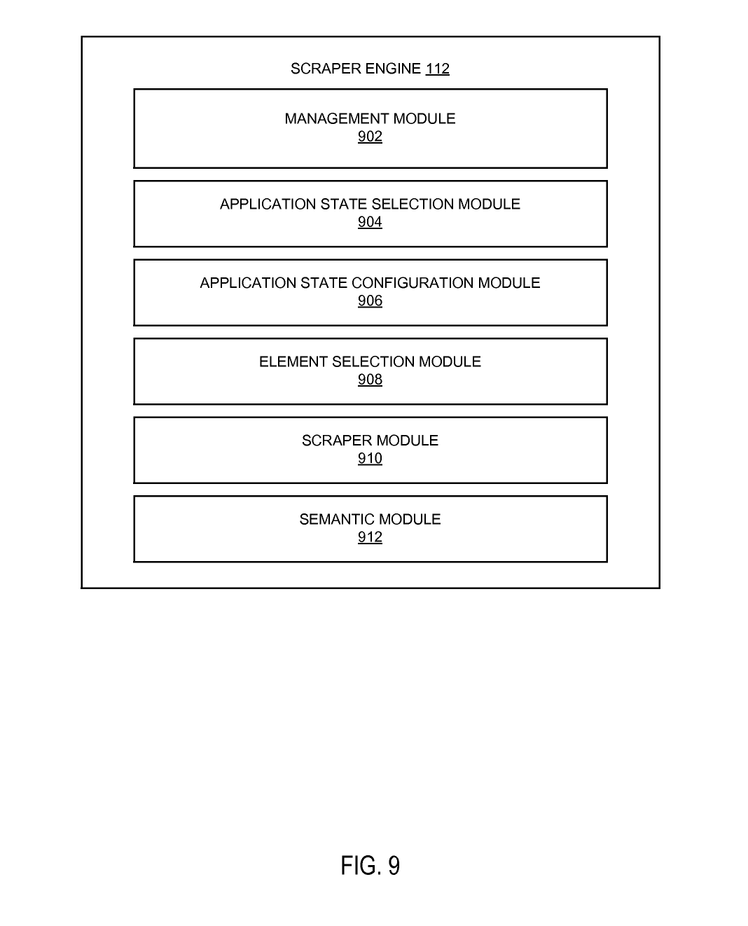

FIG. 9 shows an exemplary embodiment of the scraper engine 112 in some embodiments. As shown, the scraper engine 112 may include a management module 902, an application state selection module 904, an application state configuration module 906, an element selection module 908, a scraper module 910 and a semantic module 912. The management module 902 may be configured to receive a scrape request to scrape output from an application configured to an application state and, in response, initiate scraping of output.

In some embodiments, the management module 902 may receive a scrape request from the application exploration system 102. For example, the application exploration system 102 may transmit a scrape request to the scraper engine 112 upon discovering any number of application states of the application. Alternatively, in some embodiments, the management module 902 may receive a scrape request from an administrator, other authorized user of the application exploration system 102, or another application. For example, a user may use a client device (not shown) in network communication (via network 108) with the application exploration system 102 to transmit a scrape request to the application exploration system 102. Alternatively, a user may login to the application exploration system 102 directly and initiate a scrape request.

In some embodiments, a scrape request may include additional metadata associated with the scrape request. For example, a scrape request may include metadata identifying the location of a state access instruction report associated with the application. For instance, the knowledge base 106 may maintain state access instruction reports that are indexed according to application identifiers identifying the application associated with the state access instruction report. A scrape request may include an application identifier for the application, which may be used to locate the corresponding state access instruction report in the knowledge base 106. Alternatively or additionally, the scrape request may include a path identifier that identifies a location (e.g., file directory) where the state access instruction report for the application is located (e.g., stored). In some embodiments, the scrape request may include the state access instruction report.

A scrape request may also include metadata describing scraping parameters for scraping content from output interfaces associated with application states. For example the metadata may identify a set of application states, a set of state access instructions, a time at which to scrape output from an application when configured using one or more of the state access instructions, a priority order for scraping content (e.g., scraping content from interfaces in order of configuration based on the state access instruction prior order), and/or the like. Upon receiving a scrape request, the management module 902 may communicate with the various modules of the scraper engine 112 to initiate scraping.

In some embodiments, the management module 902 may communicate with the application state selection module 904 to initiate scraping content from output of an application configured to an application state. This may include providing the application state selection module 904 with a state access instruction report or the location of a state access instruction report that identifies state access instructions (e.g., template function instructions) corresponding to any number of application states. Further, the management module 902 may provide the application state selection module 904 with any scraping parameters regarding scraping content.

The application state selection module 904 may be configured to select a state access instruction from any number of state access instructions (e.g., state access instruction report) provided by the management module 902, the application state discovery engine 110, and/or any device. The application state selection module 904 may select a state access instruction in any number of ways. In some embodiments, the application state selection module 904 may select a state access instruction based on time of last scraping, if the content associated with the application has not yet been scraped, prioritization settings (e.g., provided by a user), or any other method.

The application state selection module 904 may select an application state. In some embodiments, the application state selection module 904 may select an application state by providing a state access instruction corresponding to the application state to one or more other modules of the scraper engine 112. For example, the application state selection module 904 may access the state access instruction report corresponding to the application and select a state access instruction listed in the state access instruction report that corresponds to the selected application state.

The state access instruction report may include a listing of template function instructions along with their corresponding parameter variable, if any. In some embodiments, the application state selection module 904 may select a template function instruction from the state access instruction report and any necessary parameter values from the knowledge system 104, to generate the state access instruction corresponding to the selected application state.

The application state selection module 904 may select application states and/or state access instructions for scraping in numerous ways and/or based on any number of factors. In some embodiments, the application state selection module 904 may select application states for selection according to the order in which the state access instructions are listed in the state access instruction report. For example, the application state selection module 904 may begin by selecting the first state access instruction listed in the state access instruction report and continue selecting state access instruction from the state access instruction reports in their listed order until the list is exhausted (e.g., each state access instruction has been selected).

In some embodiments, the application state selection module 904 may be configured to select application states according to scraping parameters provided by an administrator or other authorized user of the application exploration system 102. For example, the scraping parameters may have been received as part of the corresponding scrape request. The scraping parameters may be specific to one or more applications or general scraping parameters used by the scraper engine 102 when scraping content from any application or any subset of applications. The scraping parameters may identify a set of application states. For example, the scraping parameters may indicate that only a subset of application states from an application are to be used to configure the application to generate content to be scraped. Further, the scraping parameters may include a specified order and/or priority order to configure the application to the application states. The application state selection module 904 may select application states according to the scraping parameters.

The application state selection module 904 may provide the state access instruction corresponding to a selected application state to the application state configuration module 906. The application state configuration module 906 may use a state access instruction to configure an application to a corresponding application state. For example, in some embodiments, the application state configuration module 906 may execute the application in an emulated or virtualized environment and use the state access instruction to configure or assist in configuring the application to the corresponding application state. Upon configuring the application to the application state, a resulting output interface of the application may be scraped by the scraper engine 112.

Scraping content from output associated with an application state may include identifying User Interface (UI) elements from an output of a given application. As discussed herein, UI elements are those elements used in an output interface (e.g., a graphical user interface or GUI) that represent or refer to information indicated in that output interface. UI elements may represent content (e.g., text, image, audio, video, animation, or any media either locally stored or retrievable over a network). In one example when the output interface is coded in xml, a UI element may indicate content by defining TextView as android:text=“Restaurant review for Alexander's Steakhouse is five stars.” In various embodiments, the UI element may include a link to another application, data store, and/or a remote digital device to retrieve content to be shared with the user

UI elements may indicate and/or describe functionality (e.g., buttons, scroll bars, tabs, or the like). For example, UI elements for a particular output interface may indicate a window for content and a scroll bar associated with that window which may change the content of the window when actuated (e.g., when the window scrolls as a result of activation of the scroll bar).

In various embodiments, the scraper engine 112 may scrape an output interface depending on the UI element(s). For example, the scraper engine 112 may identify a UI element and perform functions based on the type of UI element. In some embodiments, each UI element may be associated with any number of scraper instructions. The scraper engine 112 may scrape content associated with a UI element based on the scraper instructions. Since not all UI elements may be associated with content, there may be scraper instructions that instruct the scraper engine 112 to take no action or to scan for a different UI element. The scraped content may be stored and indexed in the knowledge system 104, for example in the corpus data store 126.

In some embodiments, the element selection module 908 may identify UI elements of an output utilizing a UI element set associated with an output interface (e.g., that corresponds to an application state). The UI element set may, for example, be a document, such as an XML file, that lists the UI elements associated with an output (e.g., an output interface) of an application. For example, the ANDROID operating system may require application developers to provide a list of UI elements in an XML file for each output of an application. The UI element set (e.g., the UI XML file for ANDROID) may describe how the UI elements should be rendered. The UI elements associated with an application output may include the UI elements that may be visible in the resulting output interface associated with a particular application state. The UI element set may list the UI elements in hierarchical order corresponding to presentation of the UI elements in the application output. Each UI element identified in the UI element set may identify a UI element type. A UI element type may identify the type of UI element, for example whether the UI element is a button, text, image, scroll, or the like.

In some embodiments, the UI element set may be a standard document or file provided by the application developer and/or required by an operating system or platform for which the application is designed. Alternatively, in some embodiments, the application exploration system 102 can generate the UI element set for an output. For example, the application state discovery engine 110 may generate the UI element set while discovering application states of the application (dynamically and/or statically). In some embodiments, the application state configuration module 906 may access the UI element set when initiating the application state. For example, the application state configuration module 906 may use techniques such as method hooking while configuring the application to the application state to retrieve or generate the related UI element set.

The element selection module 908 may select a UI element to perform scraping by the scraper engine 112. In some embodiments, the element selection module 908 may select UI elements according to the order in which the UI elements appear in the UI element set for the output of the application when configured to the application state. Alternatively, the element selection module 908 may select a UI element according to a specified priority order or in any order. For example, certain UI elements may be prioritized based on any number of factors, such as location within the output interface, UI element type, and/or the like. The element selection module 908 may select a UI element from the identified UI elements in the output interface based on the specified priority order.

The element selection module 908 may provide an indication of the selected UI elements to the scraper module 910 (e.g., to retrieve and copy content associated with, represented by, or indicated by the UI element). The scraper module 910 may be able to retrieve content represented or indicated by a UI element based on the UI element type of the UI element. For example, the scraper module 910 may have access to a set of UI content instructions that provide instructions for accessing content represented or indicated by the various UI element types. In some embodiments, the UI content instructions may be stored in a data storage 114 and indexed according to their corresponding UI element type. The scraper module 910 may communicate with the data storage 114 and access the appropriate UI content instructions for any of the UI element types.

The UI content instructions may be any type of instruction or set of instructions for retrieving content represented to indicated by a UI element. In some embodiments, there may be a limited number of standard UI element types (e.g., utilized in the ANDROID operating system) and, as a result, there may be a limited number of instructions in the UI content instructions for each UI element type. Standard UI element types may be associated with a developer provided standard instruction, such as an API call, that may be used to retrieve content from the specified UI element type and the content instructions for these types of standard UI elements may be the developer provided standard instruction.

Some UI element types may not be associated with a developer provided standard instruction. In these types of instances, the UI content instructions may include steps or commands that may be used to retrieve content from represented or indicated by UI elements of the specified UI element type. For example, the UI content instructions may include instructions that utilize techniques such as application hooking to retrieve content represented or indicated by UI elements of the specified type. In some embodiments, the content instructions may include instructions that utilize techniques such as capturing a screenshot and/or Optical Character Recognition (OCR) to capture content represented or indicated by UI elements of the specified type.

Some UI elements may represented or indicated functionality including, for example, providing multiple views that may include new content in the various views. For example, UI elements may represent or indicate interactive elements such as scroll bars, tabs, and the like, that, when actuated, present alternate views that may include new content (e.g., content not presented in an initial or previous view). The UI content instructions for these types of UI elements may include instructions to actuate the interactive elements, thereby causing new content to be presented and then captured by the scraper module 910. For example, the UI content instructions may include developer provided standard instructions, such as an API call, associated with the interactive elements that cause actuation of the interactive element, resulting in presentation of any new content. In some embodiments, the UI content instructions may include coordinates associated with the location of interactive elements, and the scraper module may use the coordinates to actuate the interactive elements. The scraper module 910 may capture new content from output (e.g., associated with the UI element) after an interactive element is actuated.

The scraper module 910 may repeat the process of actuating interactive elements multiple times to capture new content. The scraper module 910 may perform the process on any number of interactive elements. For example, a UI element may include a first interactive element to scroll up and down and a second interactive element to scroll left and right. The scraper module 910 may actuate both interactive elements one or more times to cause new content to be presented and captured by the scraper module 910.

In some embodiments, this process may be repeated until all content is captured from the possible views. For example, the scraper module may actuate each interactive element until the interactive element is exhausted or has reached its limit, (e.g., the UI element can no longer be actuated).

In some instances, a UI elements may provide a large or even infinite amount of content that may be accessed by repeated selection of interactive elements represented or indicated by UI element(s). For example, an output interface of an application may present content in a loop such that content is repeated as the interactive elements are continuously actuated. In these types of instances, it may not be desirable or even possible to actuate the interactive elements until exhaustion to retrieve new content. The scraper module 910 may be configured to terminate the process of actuating the interactive elements when certain termination conditions are met. For example, a termination condition may be based on a number of times that an interactive element is actuated. The scraper module 910 may repeat the process of actuating an interactive element until the interactive element is exhausted or the interactive element has been actuated a predetermined number of times (e.g., reaches a threshold).

In various embodiments, a termination condition may be based on an elapsed time. The scraper module 910 may repeat the process of actuating an interactive element until the interactive element is exhausted or a predetermined threshold amount of time has elapsed from a time when the content represented by, indicated by, or associated with the UI element was first scraped by the scraper module 910. As another example, a termination condition may be based on the amount of content captured from the UI element. The scraper module 910 may therefore repeat the process of actuating an interactive element until the interactive element is exhausted or a predetermined threshold amount of content associated with the interactive element has been captured.

In some embodiments, a termination condition may be based on whether new content presented as a result of actuating an interactive element has already been captured. The scraper module 910 may therefore repeat the process of actuating an interactive element until the interactive element is exhausted or until a determination that new content provided as a result of actuating the interactive element has already been captured from the UI element. As a result, the scraper module 910 will not capture repeated content from the UI element. In one example, the scraper module 910 may scrape content associated with a UI element and actuate an interactive element to access new content. The scraper module 910 may compare all or some of the new content to content previously scraped. If all or some of the new content was not previously scraped, the scraper module 910 may scrape the content and actuate the interactive element to access more new content. The process may continue until the interactive element is exhausted or all or some of the new content was previously scraped.

It will be appreciated that any number of termination conditions may apply to any number of interactive elements. In some embodiments, different interactive elements may be associated with any number of termination conditions. In various embodiments, different interactive elements may be associated with different termination conditions.

The scraper module 910 may generate one or more application state output files for an application state. An application state output file may contain the content scraped from an application state. For example, the scraper module 910 may write content scraped from an application output interface associated with a particular application state to the application state output files associated with that application state. In some embodiments, the scraper module 910 may write the scraped content to the application state output file to maintain the order in which the content is presented by the output interface of the application state. For example, the scraper module may write the scraped content to the application state output file to maintain the hierarchical order of the content as presented in the output interface of the application state. Further, the scraper module 910 may label the content to identify the UI element and UI element type associated with the content that was scraped.

In some embodiments, the scraper module 910 may gather a UI element identifier from the UI elements during the scraping process. For example, UI elements may be assigned a UI element identifier by the developer of the application, which may be required by an operating system for which the application is designed. The scraper module 910 may gather this UI element identifier for the UI elements of the application, for example from the application state definition document. Alternatively, the scraper module 910 may gather the UI element identifier using techniques such as method hooking. The scraper module 910 may write the UI element identifier to the application state output file for the application.

The scraper module 910 may store the application state output files in the knowledge system 104, for example, in corpus data store 118. The application state output files may be indexed according to the application and/or application state corresponding to the application state output files. For example, the application state output files may be indexed according to the application state from which the content was scraped. The content scraped from the application sates may then be identified and accessed at a later time.

In some embodiments, the scraper engine 112 may assign a semantic meaning to the content scraped from an application state. For example, the scraper engine 112 may include a semantic module 912 configured to provide a semantic meaning to scraped content. To accomplish this, the semantic module 912 may assign a content descriptor to the scraped content. The content descriptor may categorize (e.g., assign tags) the scraped content as well as provide meaning to what the scraped content is. For example, scraped content that includes the name of a restaurant may be assigned a content descriptor such as ‘restaurant name’.

In some embodiments, the semantic module 912 may assign the scraped content an existing content descriptor. In one example, knowledge system 104 may maintain a listing of content descriptors and the scraped content may be assigned one or more of the existing content descriptors. Assigning a content descriptor to scraped content may include tagging or otherwise associating the application state output file for the scraped content with the content descriptor. In various embodiments, the tagging scheme may be shared with other systems such as, for example, the search system described herein.

In some embodiments, the semantic module 912 may generate a new content descriptor for scraped content. The semantic module 912 may add a newly generated content descriptor to the listing of content descriptors in the knowledge system 104 and assign the content descriptor to the scraped content. For example, the semantic module 912 may copy information obtained in hooking instructions at the operating system or application level. In another example, the semantic module 912 may receive description associated with content from a user.

In some embodiments, the semantic module 912 may assign a content descriptor to the scraped content based on an analysis of the scraped content. For example, the semantic module 912 may analyze the text, images, or the like included in the scraped content to determine a semantic meaning and assign a content descriptor accordingly.

Alternatively, the semantic module 912 may analyze the UI element identifier of the UI elements to determine the semantic meaning of the scraped content and assign a content descriptor. For example, application developers may assign meaningful UI element names to their UI elements. The UI element names may provide semantic meaning for the content scraped associated with the UI element. For example, a developer may assign a UI element identifier such as ‘restaurant_name’ which identifies that the scraped content includes a restaurant name. The semantic module 912 may use the UI element identifier to determine whether an existing content descriptor matches the UI element identifier and/or may be selected based on the UI element identifier. If so, the semantic module 912 may assign the content descriptor to the scraped content.

In some embodiments, the semantic module 912 may determine whether the UI element identifier has already been associated with a content descriptor and assign a content descriptor accordingly. For example, the UI element identifier may have been associated with a content descriptor in a previous version of the application or application state. The semantic module 912 may determine if the UI element identifier is known and previously associated with a content descriptor. If so, the semantic module 912 may assign the content descriptor to the scraped content accordingly.

In some embodiments, the semantic module 912 may assign the content descriptor for scraped content based on a user selection. For example, the semantic module 912 may provide a semantic interface that enables a user to view the scraped content and assign or otherwise provide an appropriate content descriptor to the scraped content.

Once stored in the knowledge system 104, the scraped content may be searched and accessed at any time. For example, in some embodiments, the scraped content may be searched according to specified key words and the resulting content may be presented in response to the search. This may include presenting the scraped content and/or data identifying the source of the scraped content, such as the application, application state, UI element, or the like, from which the content was scraped. Further, in some embodiments, the scraped content may be searched based on the content descriptors assigned to the scraped content. For example, a user may select or enter a search for a specified content descriptor and scraped content that has been assigned the specified content descriptor may be returned in response to the search.

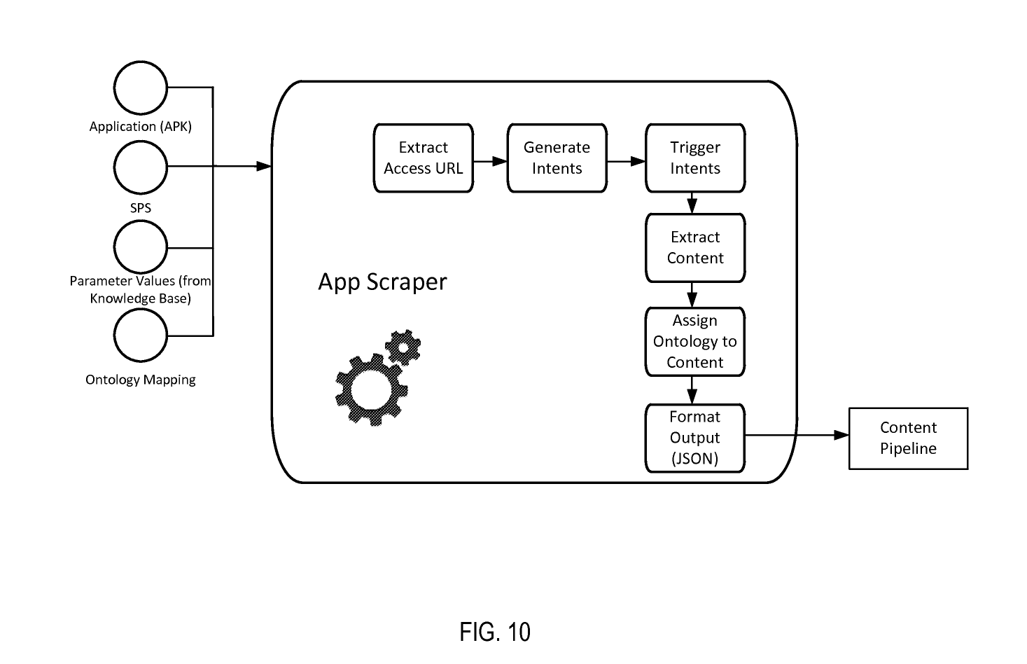

FIG. 10 shows a flow diagram of a scraper engine 112 scraping content from output interfaces generated by an application at different application states in some embodiments. As shown the scraper engine 112 may receive or have access to an application, a set of state access instructions, parameter values, and an ontology mapping. The scraper engine 112 may select an application state by identifying a state access instruction corresponding to the application state. This may include selecting a listed state access instruction or selecting a template function instruction and corresponding parameter values to generate a complete state access instruction.

The scraper engine 112 may use the selected state access instruction to configure the application to the corresponding application state. For example, the scraper engine 112 may execute the application in a virtualized or emulated environment and use the state access instruction to configure the application to the corresponding application state, resulting in an output interface of the application state.

The scraper engine 112 may then scrape content from output generated by the application when the application is configured to the application state. This may include identifying UI elements from the resulting output interface of the application and scraping content represented or indicated by UI elements of the output. The scraped content may then be assigned a content descriptor to the scraped content that provides semantic meaning. For example, the scraper engine 112 may assign a content descriptor from the ontology mapping. Further, the scraper engine 112 may generate one or more application state output files from the scraped content. An application state output file may contain the content scraped from the output of the application configured to the application state.

The application state output files may be stored and indexed according to their corresponding application, application state, UI element, assigned content descriptor, or the like. The scraped content in the application state output files may then be searched and accessed, for example, as part of a search system.

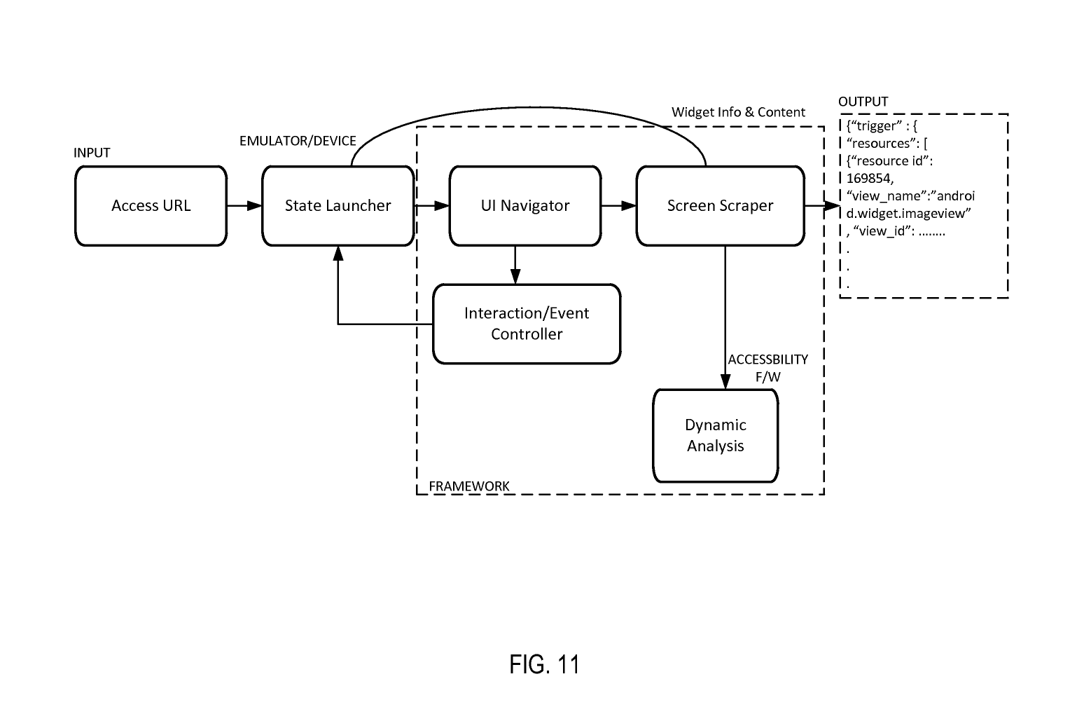

FIG. 11 shows a flow diagram of scraping content represented or indicated by a UI element in some embodiments. As shown, a state access instruction may be received as input by an application state configuration module 906 to configure an application into an application state. For example, the application state configuration module 906 may execute the application in an emulated environment or virtualized environment. The application state configuration module 906 may use the state access instruction to configure the application into the application state corresponding to the state access instruction. Configuring the application into an application state may result in an output interface of the application state. The output interface may include one or more UI elements that include content.

An element selection module 908 may identify and select the UI elements from the resulting output interface of the application state. The element selection module 908 may provide the selected UI element to the scraper module 910. The scraper module 910 may scrape content represented by the selected UI element (if any) based on UI content instructions.

The scraper module 910 may write the scraped content to one or more application state output files. Further the scraper module 910 may provide the scraped content to a semantic module 912 that may assign a content descriptor to the scraped content. The content descriptor may provide semantic meaning to the scraped content and be used to categorize the scraped content accordingly.

The element selection module 908 may select each UI element from the application state to be scraped by the scraper module 910. If the element selection module 908 has selected all UI element from the application state, the element selection module 908 may communicate with the application state configuration module 906 to request a new application state for scraping.

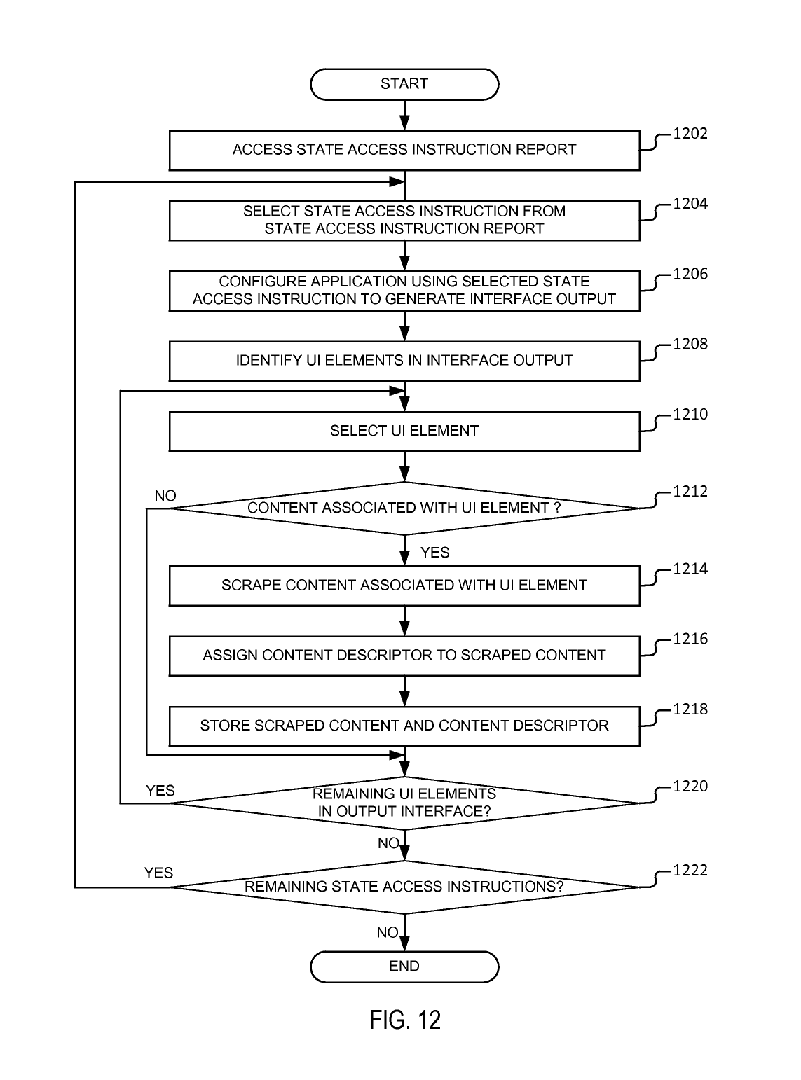

FIG. 12 is a flowchart of scraping content from an application state in some embodiments. The method begins at step 1202 where an application state selection module 904 accesses a state access instruction report. The application state selection module 904 may access the state access instruction report from a knowledge system 104 and/or a data storage 114. The state access instruction report may include a listing of state access instructions for any number of application states of an application. In one example, the state access instruction report may include a listing of template function instructions and their corresponding parameter variables for the application states.

In step 1204, the application state selection module 904 may select a state access instruction from the state access instruction report. This may include the application state selection module 904 simply selecting a listed state access instruction from the state access instruction report or, alternatively, selecting a template function instruction from the state access instruction report as well as corresponding parameter values to generate a complete state access instruction.

In some embodiments, the state selection module 904 may select state access instructions according to the order in which the state access instructions, template function instructions, and/or parameter variables are listed in the state access instruction report and/or parameter value data stores. Alternatively, the state selection module 904 may select the state access instructions according to a priority order assigned to the state access instructions and/or their corresponding application states. For example, some application states may be considered higher priority and so content from those application states may be scraped prior to content from application states considered to be lower priority. The state selection module 904 may select state access instructions according to the priority order associated with the state access instructions and/or their corresponding application states.

In step 1206, the application state configuration module 906 may configure the application using the selected state access instruction to generate the corresponding output interface. For example, the application state configuration module 906 may execute the application in an emulated or virtualized environment and use the state access instruction to configure the application to the corresponding application state. Alternatively, the state configuration module 906 may execute the application and use the state access instruction to configure the application to the corresponding application state. Configuring the application to the corresponding application state may result in generation of the output interface corresponding to the application state.

In step 1208, the element selection module 908 identifies UI elements in the output interface. For example, the element selection module 908 may identify the UI elements from an UI element set corresponding to the application state. An UI element set may be a document, such as an XML file, that lists the UI elements associated with the application state and/or describes how the UI elements should be rendered for a particular application state. The UI elements associated with an application state may include the UI elements that may be visible in the resulting output interface of the application state.

In step 1210, the element selection module 908 may select a UI element. For example, the element selection module 908 may select a UI element from the UI element set corresponding to the application state. In some embodiments, the element selection module 908 may select UI elements based on the order in which the UI elements are listed in the application state definition document. Alternatively, the element selection module 908 may select a UI element according to a specified priority order. For example, certain UI elements may be prioritized based on any number of factors, such as location within the output interface, UI element type, and/or the like. The element selection module 908 may select a UI element based on the specified priority order.

In step 1212, the element selection module 908 may determine whether there is content associated with the selected UI element. For example, some UI elements may not represent or indicate associated content that can be scraped. If the element selection module 908 determines that there is no content associated with the UI element, the method may continue to step 1220 where the element selection module 908 may determine whether there are any remaining UI elements that have not been selected.

Alternatively, if at step 1212 the element selection module 908 determines that there is content associated with the selected UI element, the method may continue to step 1214 where the scraper module 910 scrapes the content associated with the UI element. The scraper module 910 may scrape that content using content instructions for scraping content represented or indicated by UI elements. For example, the scraper module 910 may have access to a set of UI content instructions that provide instructions for accessing content from the various UI element types. The UI content instructions may be stored in a data storage 114 and indexed according to their corresponding UI element type. The scraper module 910 may communicate with the data storage 114 and access the appropriate content instructions for any of the UI element types. The scraper module 910 may then scrape content represented or indicated by the UI element according the content instructions.

At step 1216, the semantic module 912 may assign a content descriptor to the scraped content. A content descriptor may be an existing or newly generated category or tag that describes the semantic meaning of the scraped content. For example, scraped content that includes a restaurant name may be assigned a content descriptor such as “general restaurant name.”

In some embodiments, the semantic module 912 may assign a content descriptor to the scraped content based on an analysis of the scraped content. For example, the semantic module 912 may analyze the text, images, or the like included in the scraped content to determine a semantic meaning and assign a content descriptor accordingly.

Alternatively, the semantic module 912 may analyze the UI element identifier of the UI elements to determine the semantic meaning of the scraped content and assign a content descriptor. For example, application developers may assign meaningful UI element identifiers to their UI elements that may provide or be used to derive a semantic meaning for the content scraped represented or indicated by UI element. For example, a developer may assign a UI element identifier such as ‘restaurant_name’ to a UI element. This type of UI element identifier indicates that the scraped content includes a restaurant name.

The semantic module 912 may analyze the UI element identifier and determine whether the UI element identifier corresponds to an existing content descriptor. If so, the semantic module 912 may assign the content descriptor to the scraped content. If the semantic module 912 is not able to determine an existing content descriptor, the semantic module 912 may create a new content descriptor based on the UI element identifier and assign the new content descriptor to the scraped content.

In some embodiments, the semantic module 912 may determine whether the UI element identifier has already been associated with a content descriptor and assign a content descriptor accordingly. For example, the UI element identifier may have been associated with a content descriptor when a previous version of the application or application state was scraped by the scraping engine 112. The semantic module 912 may determine if the UI element identifier is known and, if so, assign a content descriptor to the scraped content accordingly. This may be advantageous when the UI element has not been assigned a meaningful UI element identifier, but rather has a UI element identifier from which a semantic meaning cannot be derived, is ambiguous, or is difficult to derive.

In some embodiments, the semantic module 912 may assign a content descriptor to scraped content based on a user selection or input. For example, the semantic module 912 may provide a user with a semantic interface that enables a user to view the scraped content and assign an appropriate content descriptor to the scraped content. The semantic interface may provide a visual representation of the scraped content, for example, as it would be shown in the output interface of the application state. A user may review the visual representation to determine the semantic meaning and assign a content descriptor accordingly. For example, the semantic interface may present the user with a listing of existing content descriptors that the user may choose from. Alternatively, the semantic interface may enable a user to enter a new content descriptor for the scraped content.

In step 1218, the semantic module 912 may store the scraped content and the content descriptor, for example, in the corpus data store 118. The scraped content may be associated with the application, application state and/or UI element from which it was scraped. Further, the scraped content can be tagged and/or associated with the assigned content descriptor.

In step 1220, the element selection module 908 may determine whether there are any remaining UI elements in the output interface that have not yet been selected. If the element selection module 908 determines that there is at least one remaining UI element, the method returns to step 1212 where the element selection module 908 selects one of the remaining UI elements to scrape associated content.

Alternatively, if the element selection module 908 determines that there are no remaining UI elements in the output interface, (e.g., all UI element in the output interface have been selected) the method continues to step 1222 where the application state selection module 904 determines whether there are any remaining state access instructions for the application that have not been selected. If the application state selection module 904 determines that there is at least one remaining state access instructions for the application (e.g., a state access instruction for the application that has not been selected), the method returns to step 1204 where the application state selection module 904 selects a new state access instruction (e.g., a state access instruction from the state access instruction report that has not yet been selected). Alternatively, if the application state selection module 904 determines that there are no remaining state access instructions for the application (e.g., all state access instructions for the application have been selected), the method may end.

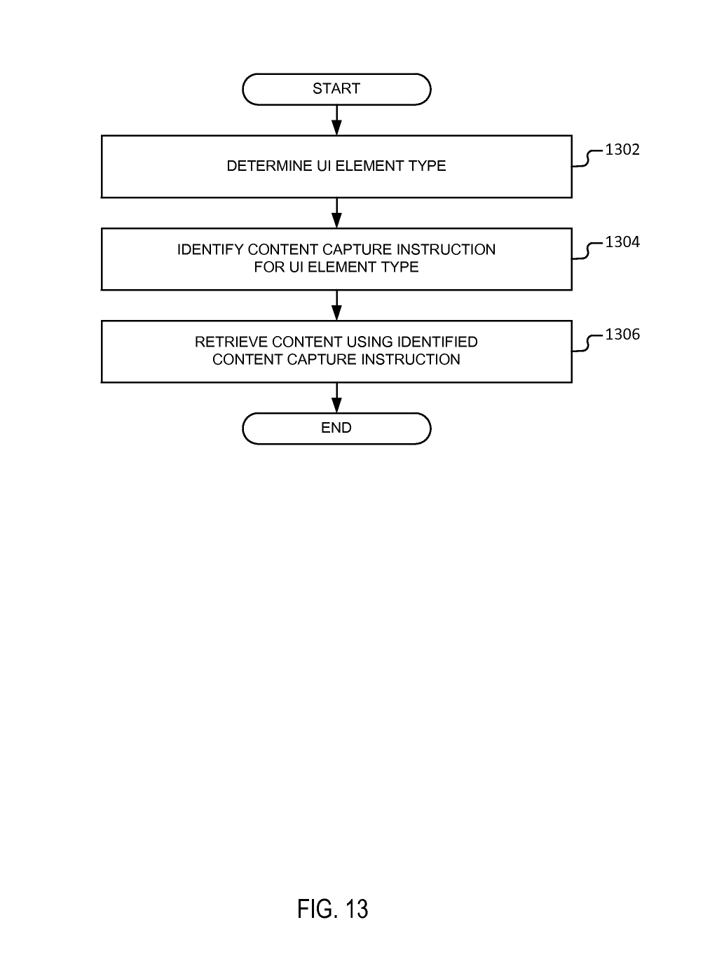

FIG. 13 is a flowchart of scraping content represented or indicated by a UI element in some embodiments. As shown, the method begins at step 1302 where the scraper module 910 determines the UI element type of the UI element. UI elements may be one of a number of UI element types, such as text, image, scrollbar, or the like. The scraper module 910 may determine the UI element type from a UI element set corresponding to the application state. A UI element set may be a document, such as an XML file, that lists the UI elements associated with the application state and/or describes how the UI elements should be rendered in the output interface resulting from a particular application state. The UI element set may identify the UI element type of each UI element from the application state and the scraper module 910 may use the UI element set to determine the UI element type for any of the UI elements.

In step 1304, the scraper module 910 may identify a UI content instruction for the UI element type. The UI content instruction may be any type of instruction or set of instructions for capturing content from a specified UI element type. For example, the UI content instruction may be a developer provided standard instruction, such as an API, that may be used to retrieve content represented or indicated by the specified UI element type.

Alternatively, some UI element types may not be associated with a developer provided standard instruction. In these types of instances, the UI content instructions may include steps or commands that may be used to retrieve content from UI elements of the specified UI element type. For example, the UI content instructions may include instructions that utilize techniques such as application hooking to retrieve content from UI elements of the specified type. In some embodiments, the UI content instructions may include instructions that utilize techniques such as capturing a screenshot and/or Optical Character Recognition (OCR) to capture content represented or indicated by UI elements of the specified type.

The scraper module 910 may have access to UI content instructions that correspond to various UI element types. The scraper module 910 may identify the UI content instructions for the UI element based on the UI element type.

In step 1306, the scraper module 910 may retrieve content represented or indicated by the UI element using the identified content instructions. For example, the scraper module 910 may execute the commands specified by the UI content instructions, such as a specified API call, application hooking techniques, screen capture, or the like. Some UI element may be configured to provide multiple views that may include new content in the various views. The UI content instructions may include commands to actuate interactive elements of the UI element(s) to change the views in the output interface, resulting in presentation of new content.

FIG. 14 is a flowchart of scraping content represented or indicated by a UI element configured to provide multiple views in some embodiments. The method begins in step 1402 where the scraper module 910 scrapes content associated with the UI element. The scraped content may be the content represented or indicated by in an initial view of the UI element.

In step 1404, the scraper module 910 executes a command to change content in the output interface. For example, the scraper module 910 may execute a command to actuate an interactive element of the UI element, such as a tab, scroll bar or the like. Actuating the interactive element may result in a secondary view of the UI element being presented in the output interface. The secondary view may include new content that was not presented in the initial view or previous view of the UI element.

In step 1406, the scraper module 910 determines whether the new content in the output interface has been previously scraped. Some UI elements may be configured to repeat presentation of content, for example in a loop. As a result, changing a view of the UI element may result in presentation of repeat content that was presented in a previous view of the output interface. The scraper module 1506 may compare the new content presented in the output interface of the UI element to content previously scraped to determine whether the new content in the output interface has been previously scraped.

If the scraper module 910 determines that the new content has been previously scraped, the method ends. Alternatively, if the scraper module 910 determines that the new content has not been previously scraped, the method continues to step 1408 where the scraper module 910 scrapes new content associated with the UI element.

In step 1410, the scraper module 910 determines whether a termination condition has been reached. A termination condition may be a condition that, if met, results in termination of scraping content represented or indicated by the UI element. For example, it may be desired to terminate scraping a UI element once a specified amount of content from the UI element has been scraped and thus one or more termination conditions may be set to restrict the amount of content scraped represented or indicated by a UI element.

In some embodiments, a termination condition may be based on whether the interactive elements of the UI element have been exhausted. For example, interactive elements such as tabs or scroll bars may become exhausted when they have been actuated to their limit, such as actuating each tab or scrolling to the limit of a scroll bar. The scraper module 910 may determine that a termination condition has been reached if one or more of the interactive elements has been exhausted.

In some embodiments, a termination condition may be based on a number of times the scraper module 910 has executed a command to change content in the output interface. For example the scraper module 910 may determine that a termination condition has been reached when the scraper module 910 has executed a command to change content in the output interface at least a threshold number of times.

In some embodiments, a termination condition may be based on an amount of elapsed time spent scraping content from the UI element. For example, the scraper module 910 may determine that a termination condition has been reached when a predetermined threshold amount of time has elapsed from a time when the scraper module 910 began scraping content from the UI element.

If the scraper module 910 determines that a termination trigger has not been reached, the method may return to step 1404 where the scraper module 910 executes a command to change content in the output interface. Alternatively, if the scraper module 910 determines that a termination trigger has been reached, the method may end.

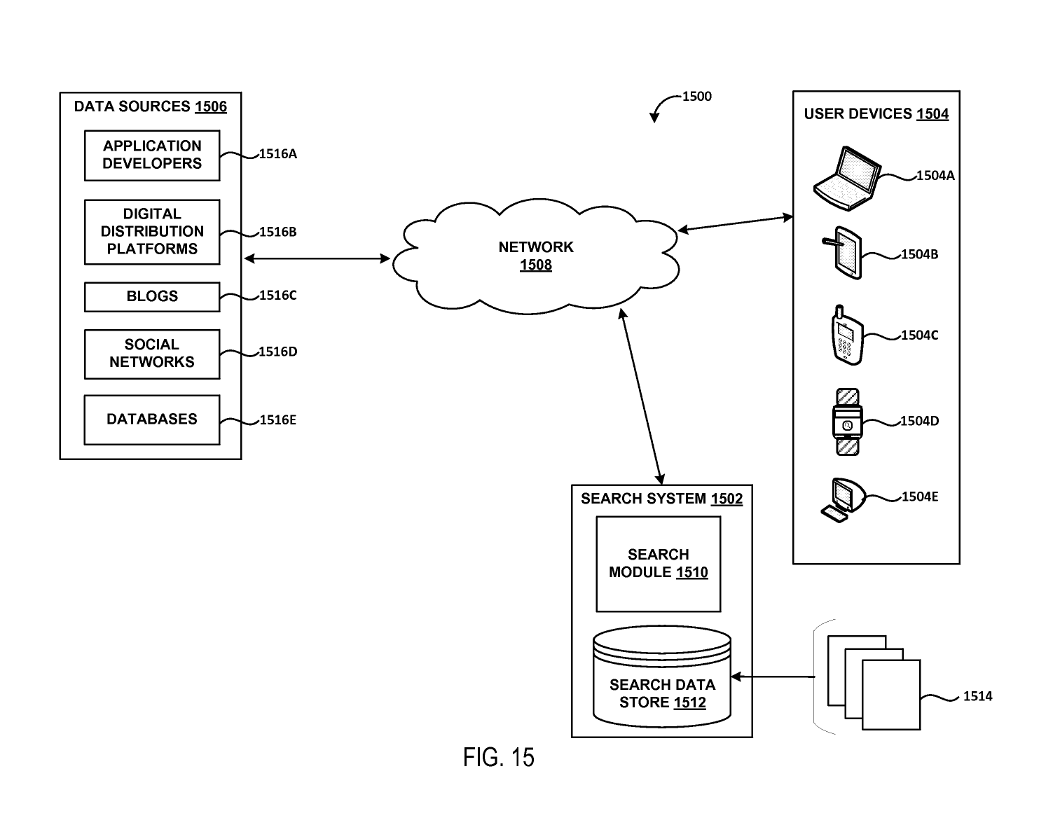

FIG. 15 is illustrates an environment 1500 including a search system 1502, user devices 1504, and data sources 1506 in communication over a network 1508 in some embodiments. The network 1508 may be any type of network, including but not limited to a local area network (“LAN”), such as an intranet, a wide area network (“WAN”), such as the Internet, or any combination thereof. Further, the network 1508 may be a public network, a private network, or a combination thereof. The network 1508 may also be implemented using any number of communications links associated with one or more service providers, including one or more wired communication links, one or more wireless communication links, or any combination thereof. Additionally, the network 1508 may be configured to support the transmission of data formatted using any number of protocols.

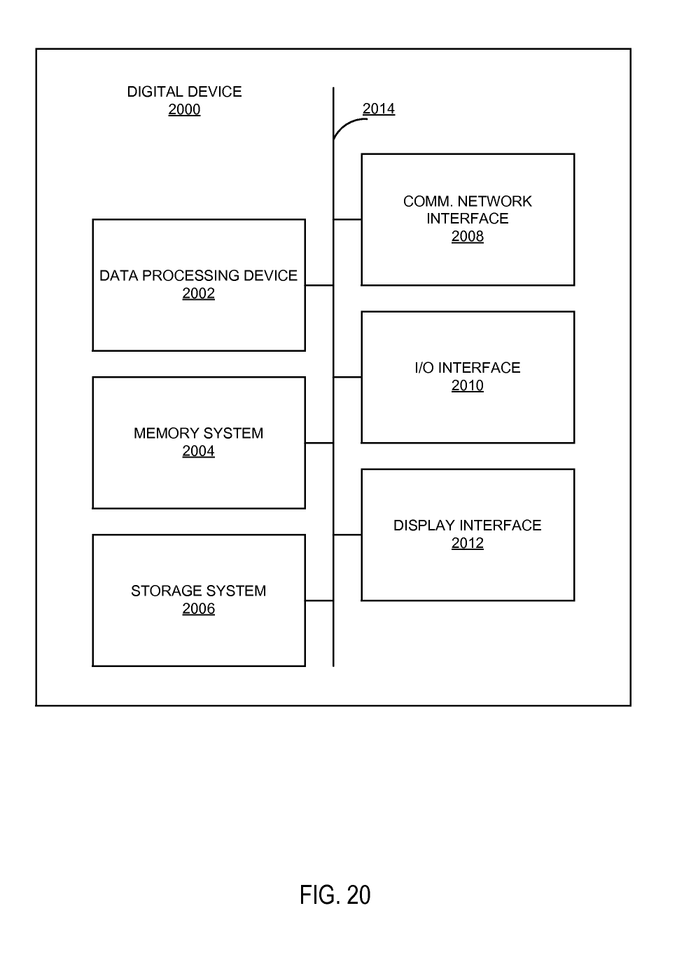

Multiple computing devices may be connected to network 1508. A computing device may be any type of general computing device (e.g., a device with a processor and memory) capable of network communication with other computing devices. For example, a computing device may be a personal computing device such as a desktop or workstation, a business server, or a portable computing device, such as a laptop, smart phone, or a tablet PC. A computing device may include some or all of the features, components, and peripherals of the digital device 2000 of FIG. 20. To facilitate communication with other computing devices, a computing device may also include a communication interface configured to receive a communication, such as a request, data, or the like, from another computing device in network communication and pass the communication along to an appropriate module running on the computing device. The communication interface may also be configured to send a communication to another computing device in network communication with the computing device.

In some embodiments, the search system 1502 receives a search query from a user device 1504, finds applications (e.g., using information from the search query), and generates search results (e.g., including links to download applications identified in the search results).

User devices 1504 can be any computing devices that are capable of providing queries to the search system 1502. User devices 1504 include, but are not limited to, mobile computing devices, such as laptops 1504a, tablets 1504b, smart phones 1504c, and wearable computing devices 1504d (e.g., headsets and/or watches). User devices 1504 may also include other computing devices having other form factors, such as computing devices included in desktop computers 1504e, vehicles, gaming devices, televisions, or other appliances (e.g., networked home automation devices and home appliances).

The user devices 1504 may use a variety of different operating systems. In examples where a user device 1504 is a mobile device, the user device 1504 may run an operating system including, but not limited to, ANDROID® developed by Google Inc., IOS® developed by Apple Inc., or WINDOWS PHONE® developed by Microsoft Corporation. Accordingly, the operating system running on the user device 1504 may include, but is not limited to, one of ANDROID®, IOS®, or WINDOWS PHONE®. In an example where a user device is a laptop or desktop computing device, the user device may run an operating system including, but not limited to, MICROSOFT WINDOWS® by Microsoft Corporation, MAC OS® by Apple, Inc., or Linux. User devices 1504 may also access the search system 1502 while running operating systems other than those operating systems described above, whether presently available or developed in the future.

Data sources 1506 may be sources of data which the search system 1502 (e.g., the search module 1510) may use to generate and update the data store 1512. The data retrieved from the data sources 1506 can include any type of data related to application functionality and/or application states. Data retrieved from the data sources 1506 may be used to create and/or update one or more databases, indices, tables (e.g., an access table), files, or other data structures included in the data store 1512. For example, application state records 1514 (discussed further herein) may be created and updated based on data retrieved from the data sources 1506. In some examples, some data included in a data source 1506 may be manually generated by a human operator. Data included in the application state records 1514 may be updated over time so that the search system 1502 provides up-to-date results.

The data sources 1506 may include a variety of different data providers. The data sources 1506 may include data from application developers 1516a, such as application developers' websites and data feeds provided by developers. The data sources 1506 may include operators of digital distribution platforms 1516b configured to distribute native applications 1026a to user devices 1504. Example digital distribution platforms 1516b include, but are not limited to, the GOOGLE PLAY® digital distribution platform by Google, Inc., the APP STORE® digital distribution platform by Apple, Inc., and WINDOWS PHONE® Store developed by Microsoft Corporation.

The data sources 1506 may also include other websites, such as websites that include web logs 1516c (i.e., blogs), application review websites or other websites including data related to applications. Additionally, the data sources 1506 may include social networking sites 1516d, such as “FACEBOOK®” by Facebook, Inc. (e.g., Facebook posts) and “TWITTER®” by Twitter Inc. (e.g., text from tweets). Data sources 1506 may also include online databases 1516e that include, but are not limited to, data related to movies, television programs, music, and restaurants. Data sources 1506 may also include additional types of data sources in addition to the data sources described above. Different data sources 1506 may have their own content and update rate.

The search system 1502 includes a search module 1510 in communication with a search data store 1512. The search data store 1512 may include one or more databases, indices (e.g., inverted indices), tables, files, or other data structures that may be used to implement the techniques of the present disclosure. The search module 1510 receives a query wrapper and generates search results based on the data included in the data store 1512. In some implementations, the search module 1510 receives a query wrapper from the user device 1504 and performs a search for application state records 1514 included in the search data store 1512 based on data included in the query wrapper, such as a search query. The application state records 1514 include one or more access mechanisms that the user device 1504 may use to access different functions for a variety of different applications, such as native applications installed on the user device 1504a. The search module 1510 may transmit search results including a list of access mechanisms to the user device 1504 that generated the query wrapper.

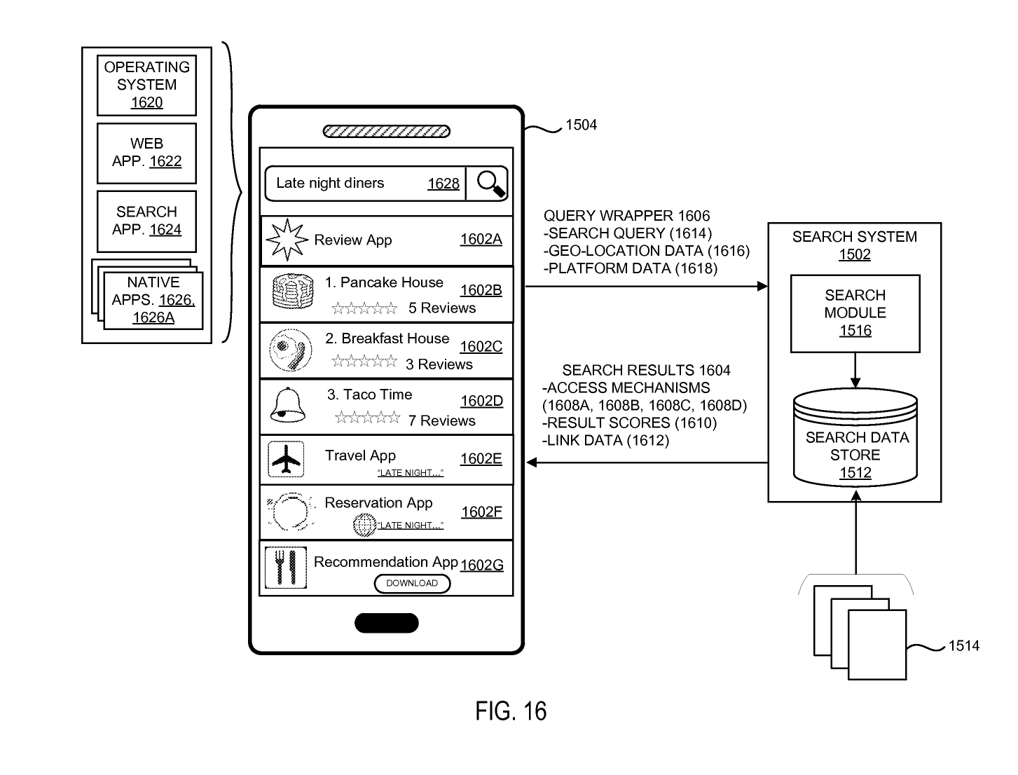

FIG. 16 shows example interaction between the user device 1504 and search system 1502 in some embodiments. In various embodiments, the user device 1504 generates user selectable links 1602a-1602g based on the received search results 1604. Each user selectable link 1602a-1602g displayed to the user may include an access mechanism 1608a-1608d. The user may select any of user selectable links 1602a-1602g on the user device 1504 by interacting with the link (e.g., touching or clicking the link). In response to selection of a link, the user device 1504 may launch a corresponding software application 1626 (e.g., a native application 1626a) referenced by the access mechanism 1608a-d and perform one or more operations indicated in the access mechanism.

Access mechanisms may each include at least one of a native application access mechanism 1608a (hereinafter “application access mechanism”), a web access mechanism 1608b, and an application download mechanism 1608c. The user device 1504 may use the access mechanisms 1608a-d to access functionality of applications 1626. For example, the user may select a user selectable link 1602a including an access mechanism 1608a in order to access functionality of an application 1626a indicated in the user selectable link 1602a. The search module 1510 may transmit one or more application access mechanisms 1608a, one or more web access mechanisms 1608, and one or more application download mechanisms 1608c to the user device 1504 in the search results 1604.

An application access mechanism 1608a may be a string that includes a reference to a native application 1626a and indicates one or more operations for the user device 1504 to perform. If a user selects a user selectable link 1602a including an application access mechanism 1608a, the user device 1504 may launch the native application 1626a referenced in the application access mechanism 1608a and perform the one or more operations indicated in the application access mechanism 1608a. The application access mechanism 1608a may be, in some embodiments, a state access instruction discovered by the application state discovery engine 170.

A web access mechanism 1608b may include a resource identifier that includes a reference to a web resource (e.g., a page of a web application/website). For example, a web access mechanism 1608b may include a uniform resource locator (URL) (e.g., a web address) used with hypertext transfer protocol (HTTP). If a user selects a user selectable link 1602f including a web access mechanism 1608b, the user device 1504 may launch the web browser application 1622 and retrieve the web resource indicated in the resource identifier. Put another way, if a user selects a user selectable link 1602f (e.g., “late night . . . ”) including a web access mechanism 1608b, the user device 1504 may launch a corresponding web browser application 1622 and access a state (e.g., a page) of a web application/website. In some examples, web access mechanisms 1608b include URLs for mobile-optimized sites and/or full sites.

An application download mechanism 1608c may indicate a location (e.g., a digital distribution platform 1506) where a native application 1626a can be downloaded in the scenario where the native application 1626a is not installed on the user device 1504. If a user selects a user selectable link 1602g including an application download mechanism 1608c, the user device 1504 may access a digital distribution platform from which the referenced native application 1626a may be downloaded. The user device 1504 may access a digital distribution platform 1526b using at least one of the web browser application 1622 and one of the native applications 1626a.

The application state access mechanism 1608d may include an application resource identifier and/or one or more operations for a user device 1504 to perform. For example, an application resource identifier may be a string having an application specific scheme. The application resource identifier may include a reference to a native application and indicate one or more operations for the user device 1504 (e.g., the native application) to perform. For example, the application resource identifier may include a reference to a native application, a domain name, and a path to be used by the native application to retrieve and display information to the user.

An example application resource identifier for the reservation native application on the android operating system is “vnd.reservationapplication.deeplink://reservationapplication.com/restaurant/profile?rid=88333 &refid=1.” A portion of the example application resource identifier references the reservation native application. For example, the substring “vnd.reservationapplication.deeplink” of the application resource identifier references the reservation native application. The example application resource identifier also indicates one or more operations for the reservation native application to perform. For example, the reservation native application may retrieve and display the information included in the application resource identifier domain and path defined by the substring “reservation application.com/restaurant/profile?rid=88333&refid=1.” In response to receiving the application resource identifier, the user device 1504 may launch the reservation native application and display information retrieved from the location indicated in the application resource identifier. The application resource identifier may be provided by the app developer in some examples.

The application state access mechanism 1608d may be, in some embodiments, a state access instruction discovered by the application state discovery engine 170.

In some examples, the application state access mechanism 1608d may include operations for the user device 1504 to perform in addition to the operation(s) indicated in the application resource identifier. For example, the search application 1624 on the user device 1504, the operating system 1620 of the user device 1504, and/or a native application 1626a installed on the user device 1504 may perform the operations included in the application state access mechanism 1608d in order to set the native application 1626a into an application state specified by the application state access mechanism 1608d. In some examples, the operations may be included in a script. Examples of operations may include, but are not limited to, launching a native application, waiting for the native application to start, creating and sending a search request to a server, setting a current geo-location in a native application, making a restaurant reservation, sending a text message, and adding an appointment to a calendar.

In some examples, the application state access mechanism 1608d may not include an application resource identifier. Instead, the application state access mechanism 1608d may include other operations that reference a native application 1626a. The operations may be performed by the user device 1504. The one or more operations may include instructions for at least one of the search application 1624, the operating system 1620, and a native application 1626a on the user device 1504. In response to selection of the application state access mechanism 1608d, the user device 1504 may perform the operations included in the application state access mechanism 1608d. In some examples, the operations may be included in a script.

The application state access mechanism 1608d may also include edition information that indicates the application edition with which the application state access mechanism 1608d is compatible. For example, the edition information may indicate the operating system with which the application state access mechanism 1608d is compatible. In some examples, the search system 1502 may determine whether to transmit the application state access mechanism 1608d in the search results 1604 based on whether the user device 1504 (e.g., operating system 1620) can handle and/or understand the application state access mechanism 1608d.

In some examples, an application resource identifier is an application specific resource identifier that is defined by the developer of the application. In this example, the search application 1624 receives the application resource identifier and the operating system 1620 may send the application resource identifier to the native application 1626a referenced in the application resource identifier. The native application 1626a referenced in the application resource identifier launches and is set into the state specified by the application resource identifier.

In some examples, an application function may not be accessible using an application state identifier. For example, a function of the application may not include a corresponding application resource identifier that the application may use to perform the function. As another example, some applications may not be configured to receive an application resource identifier. In these examples, an application state access mechanism 1608d for the native application 1626a can include one or more operations that cause the native application 1626a to perform the function that may not otherwise be accessible using an application resource identifier. For example, the search application 1624 may receive the one or more operations and execute the one or more operations to set the native application 1626a into the desired application state. In a specific example, the one or more operations may include launching the native application 1626a along with additional operations for the native application 1626a to perform. For example, the search application 1502 may initially trigger the native application 1626a to start and then wait for a period of time for the native application to start. Then the search application 1624 may perform additional operations included in the received application access mechanism 1608a, such as issuing a search instruction to the native application 1626a.

In still other examples, a native application 1626a may be configured to directly receive the operations transmitted by the search system 1502. In these examples, the native application may be launched according to the application access mechanism and then the launched native application may directly perform the operations received from the search system 1502.

A single native application can provide a variety of different functionalities. For example, a restaurant reservation application can access reviews for a variety of different restaurants and set up reservations at a variety of different restaurants. Similarly, a travel application can book hotels, book flights, and provide reviews for different travel destinations. The different functionalities associated with a single native application may be accessed using a plurality of different application access mechanisms. For example, with respect to the restaurant reservation application, the search data store 1512 may include application state records having different application access mechanisms for accessing different restaurant reviews and setting up reservations. Similarly, the search data store 1512 may include application state records having different application access mechanisms for booking hotels, booking flights, and accessing reviews for different travel destinations.

The application state access mechanisms 1608d for a single native application may vary in complexity. In some examples, the application access mechanisms may cause a native application to launch and then perform additional operations after launching, as described above. In other examples, application access mechanisms may cause an application to launch into a default state (e.g., a default homepage) without performing any additional operations. An application state record including application access mechanisms that causes an application to launch into a default state may be thought of as an access mechanism that is related to the native application, but not any particular state which may be accessed by the application. An application state record including such an application access mechanism may include application state information describing the native application, instead of any particular application state. For example, the application state information may include the name of the developer of the application, the publisher of the application, a category (e.g., genre) of the application, a description of the application (e.g., a developer's description), and the price of the application. The application state information may also include security or privacy data about the application, battery usage of the application, and bandwidth usage of the application. The application state information may also include application statistics. Application statistics may refer to numerical data related to a native application. For example, application statistics may include, but are not limited to, a number of downloads, a download rate (e.g., downloads per month), a number of ratings, and a number of reviews.

The search module 1510 is configured to receive a query wrapper 1606 from the user device 1504 via the network 1508 (see FIG. 15). A query wrapper 1606 may include a search query 1614, which may include text, numbers, and/or symbols (e.g., punctuation) entered into the user device 1504 by the user. For example, the user may enter the search query 1614 into a search field 1628 (e.g., a search box) of a graphical user interface (GUI) of a search application 1624 running on the user device 1504. A user may enter a search query 1614 using a touchscreen keypad, a mechanical keypad, a speech-to-text program, or other form of user input. In general, a search query 1614 may be a request for information retrieval (e.g., search results) from the search system 1502. For example, a search query 1614 may be directed to retrieving a list of links 1602a-g to application functionality or application states in examples where the search system 1502 is configured to generate a list of access mechanisms 1608a-d as search results 1604. A search query 1614 directed to retrieving a list of links 1602a-g to application functionality may indicate a user's desire to access functionality of one or more applications described by the search query.

In some examples, the search application 1624 may be a native application 1626a installed on the user device 1504. For example, the search application 1624 may receive search queries 1614, generate the query wrapper 1606, and display received data that is included in the search results 1604. In additional examples, the user device 1504 may execute a web browser application 1622 that accesses a web-based search application. In this example, the user may interact with the web-based search application via a web browser application 1622 installed on the user device 1504. In still more examples, the functionality attributed to the search application 1624 may be included as a searching component of a larger application 1626 that has additional functionality. For example, the functionality attributed to the search application 1624 may be included as part of a native/web application 1626a, 1622 as a feature that provides search for the native/web application 1626a, 1622.

The query wrapper 1606 may include additional data along with the search query 1614. For example, the query wrapper 1606 may include geo-location data 1616 that indicates the location of the user device 1504, such as latitude and longitude coordinates. The user device 1504 may include a global positioning system (GPS) receiver that generates the geo-location data 1616 transmitted in the query wrapper 1606. The query wrapper 1606 may also include an IP address, which the search module 1510 may use to determine the location of the user device 1504. In some examples, the query wrapper 1606 may also include additional data, including, but not limited to, platform data 1618 (e.g., version of the operating system 1620, device type, and web-browser version), an identity of a user of the user device 1504 (e.g., a username), partner specific data, and other data.

The search module 1510 can use the search query 1614 and the additional data included in the query wrapper 1606 to generate the search results 1604. For example, the search module 1510 can determine a geo-location of the user device 1504, which the search module 1510 can use along with the search query 1614 to generate the search results 1604. The search module 1510 can determine the geo-location of the user device 1504 based on the geo-location data or other data (e.g., IP address) included in the query wrapper 1606. In some implementations, the search module 1510 detects a location (e.g., a postal address, street name, city name, etc.) specified in the search query 1614 (i.e., a query-specified location). In these implementations, the search module 1510 can use the query-specified location along with the search query 1614 to generate the search results 1604.

The search module 1510 performs a search for application state records 1514 included in the search data store 1512 in response to the received query wrapper 1606 (e.g., in response to the search query 1614 and the geo-location data 1616). In some implementations, the search module 1510 generates result scores 1610 for application state records 1514 identified during the search. The result score 1610 associated with an application state record 1514 may indicate the relevance of the application state record 1514 to the search query 1614. A higher result score 1610 may indicate that the application state record 1514 is more relevant to the search query 1614. The search module 1510 may retrieve access mechanisms 1608 from the scored application state records 1514. The search module 1510 can transmit a result score 1610 along with an access mechanism 1608 retrieved from a scored application state record 1514 in order to indicate the rank of the access mechanism 1608 among other transmitted access mechanisms 1608.

In various embodiments, the search module 1510 may search for an application state access mechanism 1608d using information from the search query 1614. The search module 1510 may utilize information for the search query 1614 and identify semantic information stored by the application state discovery engine 170 to identify any number of application state access mechanisms 1608d. The semantic information may be stored within or referenced by application state records 1514. In various embodiments, the search module 1510 generates results scores for application state records 1514 based, in part, on the semantic meaning provided by the application state discovery engine 170.

In some embodiments, the search module 1510 may utilize information for the search query 1614 and identify semantic information stored by the application state discovery engine 170 to identify any number of application state access mechanisms 1608d. For example, the search module 1510 may utilize the search query 1614 and search for information such as state access instructions using scraped information from applications (e.g., scraped information that was scraped by the scraper engine 112).

It will be appreciated that the search module 1510 may search for any information including scraped information from the scraper engine 112 and/or state access instructions using information provided by the application exploration system 102 (e.g., semantic information and/or scraped information). In one example, reviews or other information (e.g., link information) may be selected and/or identified in search results 1604 from information that was previously scraped by the scraper engine 112. For example, in FIG. 16, the indication of reviews for Pancake House, Breakfast House, and Taco Time may be retrieved from previously scraped information.

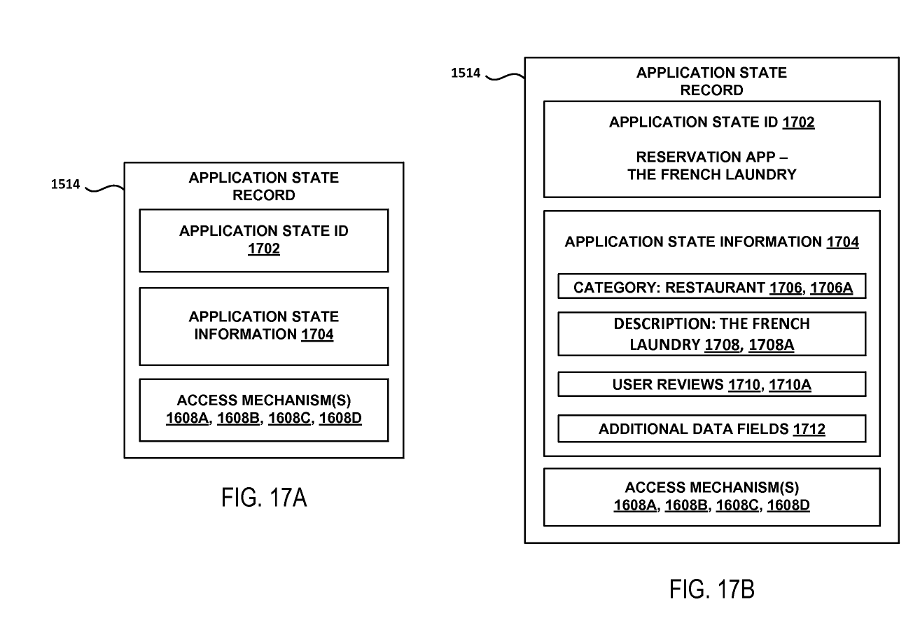

The semantic information and/or any scraped information may be stored within or referenced by application state records 1514 (see also FIGS. 17a and 17b). In various embodiments, the search module 1510 generates results scores for application state records 1514 based, in part, on the semantic meaning provided by the application state discovery engine 170 and/or any scraped information.

The search module 1510 may transmit additional data to the user device 1504 along with the access mechanisms 1608 and the result score(s) 1610. For example, the search module 1510 may transmit data (e.g., text and/or images) to be included in the user selectable links 1602. Data for the user selectable links 1602 (e.g., text and/or images) may be referred to herein as “link data.” The user device 1504 displays the user selectable links 1602 to the user based on received link data 1602. Each user selectable link 1602 may be associated with an access mechanism 1608 included in the search results 1604, such that when a user selects a link 1602, the user device 1504 launches the application 1626 referenced in the access mechanism 1608 and sets the application 1626 into the state specified by the access mechanism 1608.

The user device 1504 may receive a set of search results 1604 from the search module 1510 in response to transmission of the query wrapper 1606 to the search system 1502. The GUI of the search application 1624 displays (e.g., renders) the search results 1604 received from the search module 1510. The search application 1624 may display the search results 1604 to the user in a variety of different ways, depending on what information is transmitted to the user device 1504. In examples where the search results 1604 include a list of access mechanisms 1608 and link data, the search application 1624 may display the search results 1604 to the user as a list of user selectable links 1602 including text and images. The text and images in the links 1602 may include application names associated with the access mechanisms 1608, text describing the access mechanisms 1608, images associated with the application 1626 referenced by the access mechanisms 1608 (e.g., application icons), and images associated with the application state (e.g., application screen images) defined by the access mechanisms 1608.

In some implementations, the search application 1624 displays the search results 1604 as a list of links 1602 arranged under the search field 1628 in which the user entered the search query 1614. Moreover, the search application 1624 may arrange the links 1602 in order based on result scores 1610 associated with the access mechanisms 1608 included in the links 1602. In some examples, the search application 1624 groups the links 1602 together if the links 1602 are related to the same application 1626.

Each of the links 1602 includes link data. For example, each of the links 1602 includes an image (e.g., an icon) and text (e.g., an application or business name) that may describe an application and a state of an application. Each of the links 1602 may include an access mechanism so that if a user selects one of links 1602, the user device 1504 launches the application and sets the application into a state that is specified by the access mechanism associated with the selected link. In some implementations, the user device 1504 may arrange the links 1602 based on result scores associated with the access mechanisms included in the links 1602. In some implementations, as illustrated in FIG. 16, links 1602 for the same application 1626 may be combined together in the search results 1604 displayed to the user.

With respect to FIG. 16, it may be assumed that a review native application and a travel native application are installed on the user device 1504. A travel application may be an application that provides reviews and recommendations regarding travel, such as hotel, car rental, airline, restaurant, or the like. Links 1602a-d reference the review native application and link 1602e references the travel native application. The GUI includes a header including the name “Review App,” under which the links 1602b-d are arranged. The header may indicate that the links 1602b-d arranged below the header are associated with the review native application 1626a. Selection of link 1602b may cause the user device 1504 to launch the review native application 1626a and retrieve an Pancake House restaurant entry of the review native application 1626a. Selection of link 1602c may cause the user device 1504 to launch the review native application 1626a and retrieve a Breakfast House restaurant entry of the review native application 1626a. Selection of link 1602e may cause the user device 1504 to launch the travel native application 1626a and retrieve an entry for “Late night diners” in the travel native application 1626a (e.g., a search for “Late night diners”).

Link 1602f includes a web access mechanism 1608b (e.g., a URL). Selection of link 1602f may cause the user device 1504 to launch the web browser application 1626b and retrieve an entry for “Late night diners” in the reservation web application 1626b. Link 1602g includes an application download mechanism 1608c for the recommendation native application 1626a. Selection of link 1602g may cause the user device 1504 to access a digital distribution platform 1506 from which the recommendation native application 1626a can be downloaded and/or previewed. The search module 1510 can be configured to transmit any combination of application access mechanisms 1608a, web access mechanisms 1608b, and application download mechanisms 1608c in the search results 1604.

In some examples, user devices 1504 communicate with the search system 1502 via a partner computing system (not illustrated). The partner computing system may be a computing system of a third party that may leverage the search functionality of the search system 1502. The partner computing system may belong to a company or organization other than that which operates the search system 1502. Example third parties which may leverage the functionality of the search system 1502 may include, but are not limited to, internet search providers and wireless communications service providers. The user devices 1504 may send search queries to the search system 1502 and receive search results via the partner computing system. The partner computing system may provide a user interface to the user devices 1504 in some examples and/or modify the search experience provided on the user devices 1504.

Referring to FIGS. 17A and 17B, the search data store 1512 includes a plurality of different example application state records 1514. Each application state record 1514 may include data related to a state of the application 1626. An application state record 1514 may include an application state identifier (ID) 1702, application state information 1704, and one or more access mechanisms 1608a-d used to access functionality provided by an application 1626.

The application state ID 1702 may be used to identify the application state record 1514 among the other application state records 1514 included in the search data store 1512. The application state ID 1702 may be a string of alphabetic, numeric, and/or symbolic characters (e.g., punctuation marks) that uniquely identifies the associated application state record 1514. In some examples, the application state ID 1702 describes a function and/or an application state in human readable form. For example, the application state ID 1702 may include the name of the application 1626 referenced in the access mechanism(s) 1608. Additionally or alternatively, the application state ID 1702 may be a human readable string that describes a function performed according to the access mechanism(s) 1608 and/or an application state resulting from performance of the function according to the access mechanism(s) 1608. In some examples, the application state ID 1702 includes a string in the format of a uniform resource locator (URL) of a web access mechanism 1608b for the application state record 1514, which may uniquely identify the application state record 1514.

In a more specific example, if the application state record 1514 is for a state of the YELP® native application, the application state ID 1702 may include the name “Review Application” along with a description of the application state described in the application state information 1706. For example, the application state ID 1702 for an application state record 1514 that describes the restaurant named “The French Laundry” may be “Review Application—The French Laundry.” In an example where the application state ID 1702 includes a string in the format of a URL, the function ID 1702 may include the following string “http://www.reviewapplication.com/biz/the-french-laundry-yountville-2?ob=1” to uniquely identify the application state record 1514. In additional examples, the function ID 1702 may include a URL using a namespace other than “http://,” such as “func://.”

The application state information 1704 may include data that describes an application state into which an application 1626 is set according to the access mechanism(s) 1608 in the application state record 1514. Additionally or alternatively, the application state information 1704 may include data that describes the function performed according to the access mechanism(s) 1608 included in the application state record 1514. The application state information 1704 may include a variety of different types of data, such as structured, semi-structured, and/or unstructured data. The application state information 1704 may be automatically and/or manually generated based on documents retrieved from the data sources 1506. Moreover, the application state information 1704 may be updated so that up-to-date search results 1604 can be provided in response to a search query 1014.

In some examples, the application state information 1704 includes data that may be presented to the user by an application 1626 when the application 1626 is set in the application state defined by the access mechanism(s) 1608. For example, if one of the access mechanism(s) 1608 is an application state access mechanism 1608d, the application state information 1704 may include data that describes a state of the native application 1626a after the user device 1504 has performed the one or more operations indicated in the application state access mechanism 1608d. For example, if the application state record 1514 is associated with a shopping application, the application state information 1704 may include data that describes products (e.g., names and prices) that are shown when the shopping application is set to the application state defined by the access mechanism(s) 1608. As another example, if the application state record 1514 is associated with a music player application, the application state information 1704 may include data that describes a song (e.g., name and artist) that is played when the music player application is set to the application state defined by the access mechanism(s) 1608.

The types of data included in the application state information 1704 may depend on the type of information associated with the application state and the functionality defined by the access mechanism(s) 1608. For example, if the application state record 1514 is for an application 1626 that provides reviews of restaurants, the application state information 1704 may include information (e.g., text and numbers) related to a restaurant, such as a category of the restaurant, reviews of the restaurant, and a menu for the restaurant. In this example, the access mechanism(s) 1608 may cause the application 1626 (e.g., a native application 1626a or a web application 1622) to launch and retrieve information for the restaurant. As another example, if the application state record 1514 is for an application 1626 that plays music, the application state information 1704 may include information related to a song, such as the name of the song, the artist, lyrics, and listener reviews. In this example, the access mechanism(s) 1608 may cause the application 1626 to launch and play the song described in the application state information 1704.

FIG. 17B shows an example application state record 1514 associated with the reservation application. The reservation application is a reservation application may allow users to search for restaurants and make restaurant reservations. The reservation application provides information about restaurants including descriptions of restaurants and user reviews of the restaurants. The example application state record 1514 of FIG. 17B describes an application state of the reservation application in which the reservation application accesses information for THE FRENCH LAUNDRY® restaurant.

The example application state record 1514 includes an application state ID 1702 of “Reservation App—THE FRENCH LAUNDRY,” which may be used as a unique identifier to identify the application state record 1514. In other examples, the function ID 1702 could include a URL as a unique identifier for the application state record 1514. For example, the application state ID 1702 may include the string “http://www.reservationapplication.com/the-french-laundry” as a unique identifier for the application state record 1514. As described herein, such an application state ID may be included in a web access mechanism 1608b of an application state record 1514. As another example, the function ID 1702 may have a different namespace than “http://,” such as “func://.” In yet another example, the function ID 1702 could be a string of characters, numbers, and/or symbols that are not in human readable form. Each example is optional and may be combined with other examples.

The example application state information 1704 includes data fields such as a category 1706a of THE FRENCH LAUNDRY® restaurant, a description 1708a of THE FRENCH LAUNDRY® restaurant, user reviews 1710a of THE FRENCH LAUNDRY® restaurant, and additional data fields 1714. The restaurant category 1706 field may include the text “French cuisine” and “contemporary,” for example. The description field 1708 may include text that describes THE FRENCH LAUNDRY® restaurant. The user reviews field 1710 may include text of user reviews for THE FRENCH LAUNDRY® restaurant. The additional data fields 1712 may include additional data for THE FRENCH LAUNDRY® restaurant that may not specifically fit within the other defined fields, such as a menu for the restaurant, prices, and operating hours for the restaurant.

The application state record 1514 includes one or more access mechanism(s) 1608. The access mechanism(s) 1608 may include a reference to the reservation application 1626. An example application access mechanism 1608a for the application state record 1514 may include a reference to the reservation native application 1626a along with one or more operations to be performed by the user device 1504. For example, the application access mechanism 1608a may include an application resource identifier and/or one or more operations that cause the user device 1504 to access the entry for THE FRENCH LAUNDRY® restaurant in the reservation native application. An example application resource identifier may be “vnd.reservationapplication.deeplink://reservationapplication.com/restaurant/profile?rid=1780&r efid=1.”

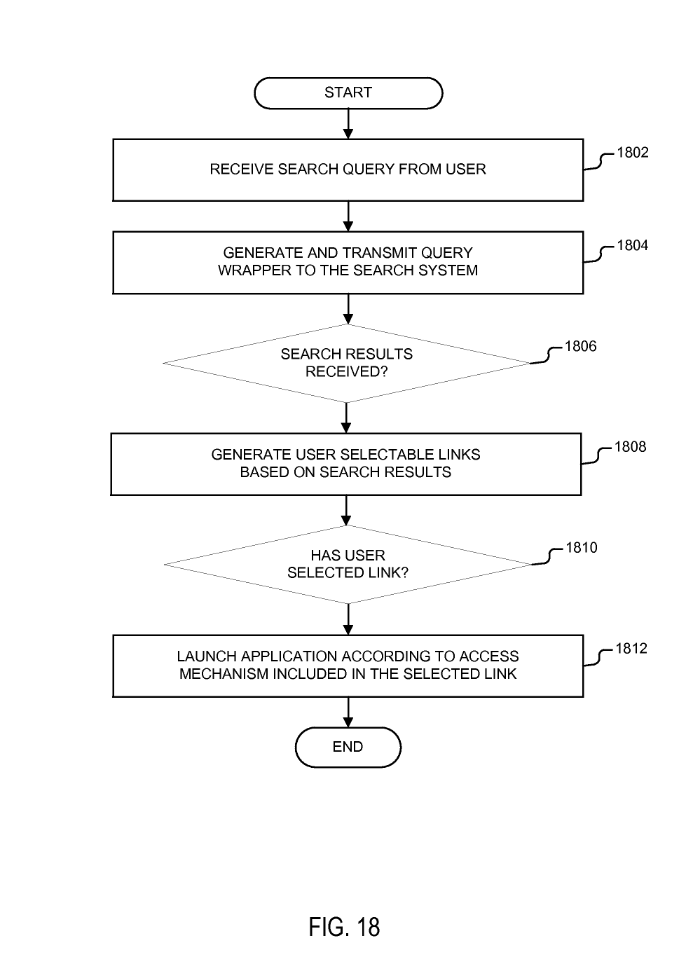

FIG. 18 provides an example arrangement of operations for a method 1800 of operating a user device 1504. It may be assumed that the user device 1504 described according to the method 1800 includes a search application 1624 (e.g., a native application 1626a or web browser application 1622) configured to communicate with the search system 1502.

In step 1802, the method 1200 includes receiving a search query 1614 (see FIG. 16) from a user. In some implementations, the search application 1624 executing on the user device 1504 receives the search query 1614 from of the user. In step 1804, the method includes generating and transmitting query wrapper 1606 to the search system 1502. In some implementations, the user device 1504 generates and transmits the query wrapper 1606 to the search system 1502. In step 1806, the method 1200 includes waiting for receipt of the search results 1604. For example, the user device 1504 waits for receipt of the search results 1604 from the search system 1502. The method 1200 continues to step 1808 when the user device 1504 receives the search results 1604 from the search system 1502. The search results 1604 may include a list of access mechanisms 1608 and optionally result scores 1610 associated with the access mechanisms 1608. Additionally, the search results 1604 may optionally include link data (e.g., text and/or images) for the access mechanisms 1608. The search application 1624 may generate user selectable links 1602 in the GUI based on the received link data 1602.

In step 1808, the method 1200 includes generating user selectable links 1602 based on the search results 1604. The search application 1624 may generate the user selectable links 1602. In step 1810, the method includes waiting for a user selection of a link 1602. The search application 1624 may wait for the user to select one of the user selectable links 1602 before operation proceeds to step 1812. When the user selects (e.g., touches) one of the links 1602, the method 1200 includes launching an application 1626 associated with the link 1602. For example, in response to selection of a link 1602 including an access mechanism 1608, the user device 1504 launches the application 1626 referenced in the access mechanism 1608 and performs one or more operations indicated in the access mechanism 1608 in step 1812.

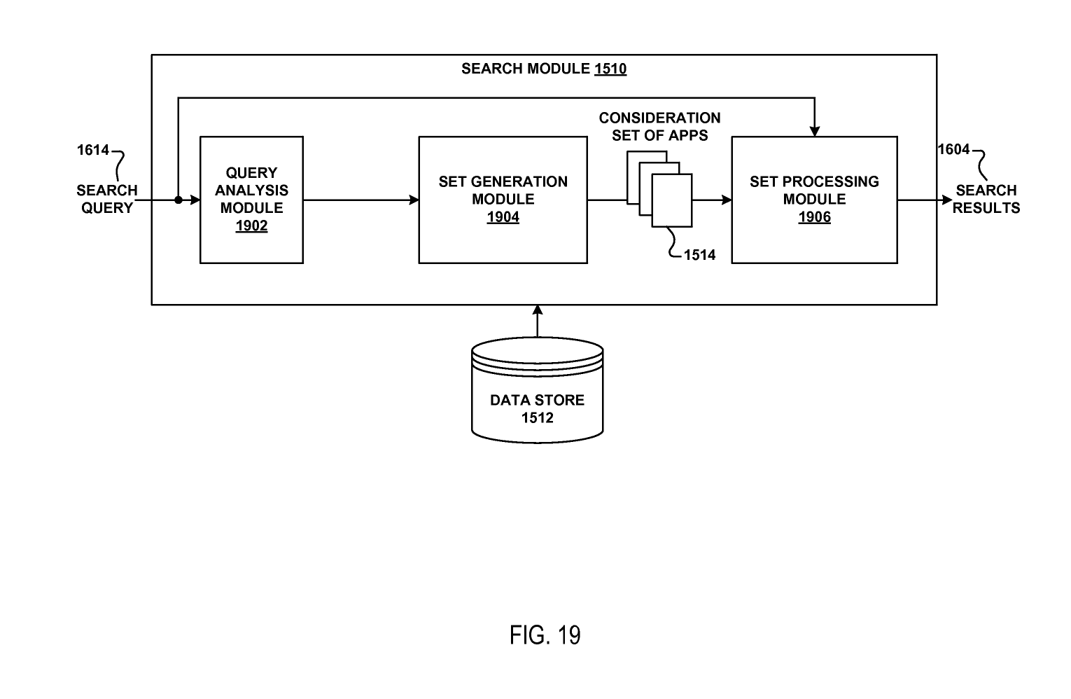

FIG. 19 depicts a search module 1510 in some embodiments. The search query 1614 received by the search module 1510 is used to perform a search of the data store 1512. The query analysis module 1902 receives the search query 1614. The query analysis module 1902 may perform various analysis operations on the received search query 1614. For example, analysis operations performed by the query analysis module 1902 may include, but are not limited to, tokenization of the search query, filtering of the search query, stemming, synonymization, and stop word removal.

The set generation module 1904 identifies a set of application state records (i.e., the consideration set) based on the search query 1614. In some examples, the set generation module 1904 may identify the set of application state records based on matches between terms of the search query 1614 and terms in the application state records. For example, the set generation module 1904 may identify a set of application state records in the data store 1512 based on matches between tokens generated by the query analysis module 1902 and words included in the application state records, such as words included in the application state information and/or application state IDs.

The set processing module 1906 processes the consideration set to generate a set of search results 1604 that includes a list of application access mechanisms. In some examples, the set processing module 1906 scores the functions records included in the consideration set. The scores associated with the application state records may be referred to as “result scores.” Accordingly, in some examples, each of the application state records in the consideration set may have a corresponding result score. The set processing module 1906 may then select application state records from the consideration set based on the result scores associated with the application state records. For example, the set processing module 1906 may select the highest scoring application state records of the consideration set.

The set processing module 1906 selects application access mechanisms from the selected application state records (e.g., the highest scoring application state records). The set processing module 1906 transmits the selected application access mechanisms to the user device 1504 that generated the search query 1614. The set processing module 1906 may also transmit the result scores associated with the selected application access mechanisms. For example, an application access mechanism may be associated with the result score of the application state record from which the application access mechanism was selected.

The information conveyed by the search results 1604 may depend on how the result scores are calculated by the set processing module 1906. For example, the result scores may indicate the relevance of an application function or application state to the search query 1614, the popularity of an application function or state, or other properties of the application function or state, depending on what parameters the set processing module 1906 uses to score the application state records.

The set processing module 1906 may generate result scores for application state records in a variety of different ways. In some implementations, the set processing module 1906 generates a result score for an application state record based on one or more scoring features. The scoring features may be associated with the application state record and/or the search query 1614. An application state record scoring feature (hereinafter “record scoring feature”) may be based on any data associated with an application state record. For example, record scoring features may be based on any data included in the application state information of the application state record. Example record scoring features may be a quality score, whether the application state record includes an application access mechanism that leads to a default state or a deeper native application state, and, for newly generated application state records, the number of application state records used to generate the newly generated application state record, as described hereinafter. A query scoring feature may include any data associated with the search query 1614. For example, query scoring features may include, but are not limited to, a number of words in the search query 1614, the popularity of the search query 1614, and the expected frequency of the words in the search query 1614. A record-query scoring feature may include any data that may be generated based on data associated with both the application state record and the search query 1614 that resulted in identification of the application state record by the set generation module 1904. For example, record-query scoring features may include, but are not limited to, parameters that indicate how well the terms of the search query 1614 match the terms of the application state information of the identified application state record. The set processing module 1906 may generate a result score for application state record based on at least one of the record scoring features, the query scoring features, and the record-query scoring features.

The set processing module 1906 may determine a result score based on one or more of the scoring features listed herein and/or additional scoring features not explicitly listed. In some examples, the set processing module 1906 may include one or more machine learning models (e.g., a supervised learning model) configured to receive one or more scoring features. The one or more machine learned models may generate result scores based on at least one of the record scoring features, the query scoring features, and the record-query scoring features. For example, the set processing module 1906 may pair the search query 1614 with each application state record and calculate a vector of features for each (query, record) pair. The vector of features may include one or more record scoring features, one or more query scoring features, and one or more record-query scoring features. The set processing module 1906 may then input the vector of features into a machine-learned regression model to calculate a result score for the application state record. In some examples, the machine-learned regression model may include a set of decision trees (e.g., gradient boosted decision trees). In another example, the machine-learned regression model may include a logistic probability formula. In some examples, the machine learned task can be framed as a semi-supervised learning task, where a minority of the training data is labeled with human curated scores and the rest are used without human labels.

The result scores 1610 associated with the application state records 1514 (e.g., access mechanisms 1608) may be used in a variety of different ways. The set processing module 1906 and/or the user device 1504 may rank the access mechanisms 1608 based on the result scores 1610 associated with the access mechanisms 1608. In these examples, a larger result score may indicate that the access mechanism 1608 (e.g., the function or application state) is more relevant to a user than an access mechanism 1608 having a smaller result score. In examples where the user device 1504 displays the search results 1604 as a list, the user device 1504 may display the links 1602 for access mechanisms 1608 having larger result scores 1610 nearer to the top of the results list (e.g., near to the top of the screen). In these examples, the user device 1504 may display the links 1602 for access mechanisms 1608 having lower result scores 1610 farther down the list (e.g., off screen).

FIG. 20 is a block diagram of an exemplary digital device 2000. The digital device 2000 comprises a processor 2002, a memory system 2004, a storage system 2006, a communication network interface 2008, an I/O interface 2010, and a display interface 2012 communicatively coupled to a bus 2014. The processor 2002 is configured to execute executable instructions (e.g., programs). In some embodiments, the processor 2002 comprises circuitry or any processor capable of processing the executable instructions.

The memory system 2004 is any memory configured to store data. Some examples of the memory system 2004 are storage devices, such as RAM or ROM. The memory system 2004 may comprise the cache memory. In various embodiments, data is stored within the memory system 2004. The data within the memory system 2004 may be cleared or ultimately transferred to the storage system 2006.

The storage system 2006 is any storage configured to retrieve and store data. Some examples of the storage system 2006 are flash drives, hard drives, optical drives, and/or magnetic tape. The storage system 2006 may comprise non-transitory media. In some embodiments, the digital device 2000 includes a memory system 2004 in the form of RAM and a storage system 2006 in the form of flash data. Both the memory system 2004 and the storage system 2006 comprise computer readable media which may store instructions or programs that are executable by a computer processor including the processor 2002.

The communication network interface (com. network interface) 2008 may be coupled to a network (e.g., network 108) via the link 2016. The communication network interface 2008 may support communication over an Ethernet connection, a serial connection, a parallel connection, or an ATA connection, for example. The communication network interface 2008 may also support wireless communication (e.g., 802.17 a/b/g/n, WiMax). It will be apparent to that the communication network interface 2008 may support many wired and wireless standards.

The optional input/output (I/O) interface 2010 is any device that receives input from the user and output data. The optional display interface 2012 is any device that is configured to output graphics and data to a display. In one example, the display interface 2012 is a graphics adapter. It will be appreciated that not all digital devices 2000 comprise either the I/O interface 2010 or the display interface 2012.

The hardware elements of the digital device 2000 are not limited to those depicted in FIG. 20. A digital device 2000 may comprise more or less hardware elements than those depicted. Further, hardware elements may share functionality and still be within various embodiments described herein. In one example, encoding and/or decoding may be performed by the processor 2002 and/or a co-processor, such as a processor located on a graphics processing unit (GPU).

The above-described functions and components may be comprised of instructions that are stored on a storage medium such as a computer readable medium (e.g., a non-transitory computer readable medium). The instructions may be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with embodiments of the present invention.

The present invention is described above with reference to exemplary embodiments. Various modifications may be made and other embodiments may be used without departing from the broader scope of the present invention. Therefore, these and other variations upon the exemplary embodiments are intended to be covered by the present invention.

1. A method comprising:
configuring an application into a first application state, the configuring performed using a first state access instruction associated with the first application state and resulting in a first output interface provided by the application;
selecting a first UI element from the first output interface, the first UI element indicating first content;
determining that the first UI element is of a first UI element type;
selecting first UI content instructions corresponding the first UI element type, the first UI content instructions including a first set of actions to retrieve content indicated by UI elements of the first UI element type; and
executing the first set of actions to retrieve the first content indicated by the first UI element.

2. The method of claim 1, further comprising:
selecting a second UI element from the first output interface of the first application state, the second UI element indicating second content;
determining that the second UI element is of a second UI element type;
selecting second UI content instructions corresponding to the second UI element type, the second content instructions including a second set of actions to retrieve content indicated by the UI element of the second UI element type; and
executing the second set of actions to retrieve the second content indicated by the second UI element.

3. The method of claim 1, further comprising:
accessing a first UI element set corresponding to the first application state, the first UI element set including data describing a first set of UI elements included in the first output interface, the first UI element selected from the first set of UI elements.

4. The method of claim 1, further comprising:
selecting, from a state access instruction report, the first state access instruction, the state access instruction report listing a set of state access instructions corresponding to a set of application states of the first application.

5. The method of claim 4, further comprising:
determining that each UI element from a set of UI elements of the first application has been selected;
selecting, from the state access instruction report, a second state access instruction corresponding to a second application state of the first application.

6. The method of claim 1, wherein executing the first set of actions comprises:
executing a developer provided standard instruction for the first UI element type, the developer provided standard instruction configured to return content indicated by UI elements of the first UI element type.

7. The method of claim 1, wherein executing the first set of actions comprises:
retrieving the first content indicated by the first UI element, the first content presented in an initial view of the first UI element; and
actuating a first interactive element associated with the first UI element, resulting in a secondary view including a second content.

8. The method of claim 7, wherein executing the first set of actions further comprises:
retrieving the second content.

9. The method of claim 7, wherein executing the first set of actions further comprises:
determining whether at least a portion of the second content has already been retrieved, wherein, when at least a portion of the second content has already been retrieved, the second content is not retrieved from the first UI element.

10. The method of claim 7, wherein executing the first set of actions further comprises:
determining whether a termination condition has been met, wherein when a termination condition has been met, the termination condition indicating that no more content associated with the UI element should be retrieved.

11. The method of claim 10, wherein determining whether a termination condition has been met comprises:
determining whether an amount of content retrieved associated with the first UI element meets or exceeds a predetermined threshold amount of content to be retrieved.

12. The method of claim 10, wherein determining whether a termination condition has been met comprises:
determining whether a length of elapsed time associated with retrieving content indicated by the first UI element meets or exceeds a threshold length of time to be spent retrieving content.

13. The method of claim 10, wherein determining whether a termination condition has been met comprises:
determining whether a number of times that interactive elements associated with the first UI element have been actuated meets or exceeds a threshold number of interactive element actuations.

14. The method of claim 10, wherein determining whether a termination condition has been met comprises:
determining whether the first interactive element of the first element has been exhausted.

15. A system comprising:
an application state configuration module configured to configure an application into a first application state, the configuring performed using a first state access instruction associated with the first application state and resulting in a first output interface provided by the application;
an element selection module configured to select a first UI element from the first output interface, the first UI element indicating first content, and determine that the first UI element is of a first UI element type; and
a scraper module configured to select first UI content instructions corresponding the first UI element type, the first UI content instructions including a first set of actions to retrieve content indicated by UI elements of the first UI element type, and execute the first set of actions to retrieve the first content indicated by the first UI element.

16. The system of claim 15, wherein:
the element selection module is further configured to select a second UI element from the first output interface of the first application state, the second UI element indicating second content, and determine that the second UI element is of a second UI element type; and
the scraper module is further configured to select second UI content instructions corresponding to the second UI element type, the second content instructions including a second set of actions to retrieve content indicated by the UI element of the second UI element type, and executing the second set of actions to retrieve the second content indicated by the second UI element.

17. The system of claim 15, wherein the element selection module is further configured to access a first UI element set corresponding to the first application state, the first UI element set including data describing a first set of UI elements included in the first output interface, the first UI element selected from the first set of UI elements.

18. The system of claim 15, further comprising an application state selection module configured to select, from a state access instruction report, the first state access instruction, the state access instruction report listing a set of state access instructions corresponding to a set of application states of the first application.

19. The system of claim 18, wherein:
the element selection module is further configured to determine that each UI element from a set of UI elements of the first application has been selected; and
the application state selection module is further configured to select, from the state access instruction report, a second state access instruction corresponding to a second application state of the first application.

20. The system of claim 15, wherein executing the first set of actions comprises:
executing a developer provided standard instruction for the first UI element type, the developer provided standard instruction configured to return content indicated by UI elements of the first UI element type.

21. The system of claim 15, wherein executing the first set of actions comprises:
retrieving the first content indicated by the first UI element, the first content presented in an initial view of the first UI element; and
actuating a first interactive element associated with the first UI element, resulting in a secondary view including a second content.

22. The system of claim 21, wherein executing the first set of actions further comprises:
retrieving the second content.

23. The system of claim 21, wherein executing the first set of actions further comprises:
determining whether at least a portion of the second content has already been retrieved, wherein, when at least a portion of the second content has already been retrieved, the second content is not retrieved from the first UI element.

24. The system of claim 21, wherein executing the first set of actions further comprises:
determining whether a termination condition has been met, wherein when a termination condition has been met, the termination condition indicating that no more content associated with the UI element should be retrieved.

25. The system of claim 24, wherein determining whether a termination condition has been met comprises:
determining whether an amount of content retrieved associated with the first UI element meets or exceeds a predetermined threshold amount of content to be retrieved.

26. The system of claim 24, wherein determining whether a termination condition has been met comprises:
determining whether a length of elapsed time associated with retrieving content indicated by the first UI element meets or exceeds a threshold length of time to be spent retrieving content.

27. The system of claim 24, wherein determining whether a termination condition has been met comprises:
determining whether a number of times that interactive elements associated with the first UI element have been actuated meets or exceeds a threshold number of interactive element actuations.

28. The system of claim 10, wherein determining whether a termination condition has been met comprises:
determining whether the first interactive element of the first element has been exhausted.

29. A non-transitory computer readable medium comprising executable instructions, the instructions being executable by a data processing device to perform a method, the method comprising:
configuring an application into a first application state, the configuring performed using a first state access instruction associated with the first application state and resulting in a first output interface provided by the application;
selecting a first UI element from the first output interface, the first UI element indicating first content;
determining that the first UI element is of a first UI element type;
selecting first UI content instructions corresponding the first UI element type, the first UI content instructions including a first set of actions to retrieve content indicated by UI elements of the first UI element type; and
executing the first set of actions to retrieve the first content indicated by the first UI element.
